(19) United States
(12) Patent Application Publication
(10) Pub. No.: US 2026/0144180 A1
(43) Pub. Date: May 28, 2026

(54) MOUNTING DEVICE OF AGRICULTURAL WORK MACHINE

(71) Applicant: LS MTRON LTD., Anyang-si, Gyeonggi-do (KR)

(72) Inventors: Dong Ho YANG, Anyang-si, Gyeonggi-do (KR); Jae Seop PARK, Anyang-si, Gyeonggi-do (KR); Gun Young NA, Anyang-si, Gyeonggi-do (KR); Jung Sik KI, Anyang-si, Gyeonggi-do (KR); Gi Myeong PARK, Anyang-si, Gyeonggi-do (KR)

(21) Appl. No.: 18/706,310

(22) PCT Filed: Nov. 2, 2022
(86) PCT No.: PCT/KR2022/016972

§ 371 Date: Apr. 30, 2024

(30) Foreign Application Priority Data
Nov. 3, 2021 (KR) 10-2021-0149510

(51) Int. Cl. A01B 59/00; A01B 59/042

(52) U.S. Cl. CPC A01B 59/002; A01B 59/042

(57) ABSTRACT

The present disclosure relates to a mounting device of an agricultural work machine, the device comprising: a mounting part which is coupled to an agricultural work machine and is configured to be detachably mounted to a mounting plate of an agricultural work vehicle; a mounting controller which is coupled to the agricultural work machine and is configured to control movement of the mounting part; an operation part which is coupled to the mounting controller and is configured to move the mounting controller; and an operation restriction part for restricting movement of the operation part.

### CROSS-REFERENCE TO RELATED APPLICATION

This application is a National Stage of International Application No. PCT/KR2022/016972, filed Nov. 2, 2022, which claims priority to and the benefit of Korean Patent Application No. 10-2021-0149510, filed Nov. 3, 2021, the disclosures of which are incorporated herein by reference in its entirety.

### FIELD

The present disclosure relates to a mounting device of an agricultural work machine, which is used to mount an agricultural work machine on an agricultural work vehicle.

### BACKGROUND

Agricultural work vehicles are used to cultivate crops necessary for human life using land. For example, combines and tractors correspond to agricultural work vehicles. A combine carries out harvesting and threshing crops like rice, barley, wheat, and soybeans. A tractor performs operations necessary for cultivating crops using traction power.

Such agricultural work vehicles can perform various operations through agricultural work machines. For instance, the agricultural work vehicle can be equipped with an agricultural work machine such as a backhoe. The backhoe is used for excavation work. Such an agricultural work machine is detachably mounted on the agricultural work vehicle.

When the agricultural work vehicle does not need any agricultural work machine such as when the agricultural work vehicle only needs to travel, or performs tasks without any agricultural work machine, or when there is a need to replace with different types of agricultural work machines, a detachment operation of the agricultural work machine from the agricultural work vehicle can be performed. Such detachment operation of the agricultural work machine can be carried out by detaching mounting pins, which are formed in the agricultural work machine and inserted into support holes formed in a mounting stand of the agricultural work vehicle, from the mounting holes of the agricultural work vehicle.

When the agricultural work vehicle performs operations using the agricultural work machine, a mounting operation of mounting the agricultural work machine on the agricultural work vehicle can be performed. The mounting operation of the agricultural work machine can be carried out by inserting the mounting pins into support holes and the mounting holes while overlapping the support holes and the mounting holes.

Here, since agricultural work machine is a heavy object with substantial weight, it is difficult to align the mounting stand of the agricultural work vehicle and the agricultural work machine so that the support holes and mounting holes overlap when the mounting operation of the agricultural work machine is performed. Additionally, when the detachment operation of the agricultural work machine is performed, it is difficult to detach the mounting pins from the support holes and the mounting holes due to the weight of the agricultural work machine. Accordingly, traditionally, the mounting and detachment operations of the agricultural work machine using holes and pins have been performed, so the difficulty in mounting and detachment operations of the agricultural work machine was increased. In addition, there has been a risk of accidents during the mounting and detachment operations of the agricultural work machine due to the weight of the agricultural work machines.

### SUMMARY

Accordingly, the present disclosure has been made in view of the above-mentioned problems occurring in the related art, and it is an object of the present disclosure to provide a mounting device of an agricultural work machine, which can reduce the difficulties in mounting and detachment operations of an agricultural work machine.

It is another object of the present disclosure to provide a mounting device of an agricultural work machine, which can reduce a risk of accidents during the mounting and detachment operations of the agricultural work machine.

To overcome the aforementioned problems, the present disclosure may include the following configurations.

An agricultural work machine mounting device according to the present disclosure can include: a mounting part which is coupled to an agricultural work machine and is configured to be detachably mounted to an agricultural work vehicle; a mounting controller which is coupled to the agricultural work machine and is configured to control movement of the mounting part; an operation part which is coupled to the mounting controller and is configured to move the mounting controller; and an operation restriction part for restricting movement of the operation part.

In the agricultural work machine mounting device according to the present disclosure, the mounting part includes a first mounting mechanism rotatably coupled to the agricultural work machine, a second mounting mechanism rotatably coupled to the agricultural work machine, and an elastic mechanism providing elastic force to the first and second mounting mechanisms in a direction where a first mounting groove formed in the first mounting mechanism and a second mounting groove formed in the second mounting mechanism are spaced apart.

In the agricultural work machine mounting device according to the present disclosure, the mounting controller is rotatably coupled to the agricultural work machine between a restriction position, where the mounting controller is inserted into a restriction groove of the mounting part to restrict the movement of the first mounting mechanism and the second mounting mechanism, and a permission position, where the mounting controller is spaced from the restriction groove to allow the movement of the first mounting mechanism and the second mounting mechanism by the elastic force of the elastic mechanism.

In the agricultural work machine mounting device according to the present disclosure, the operation part moves between a first operation position, which locates the mounting controller at the restriction position, and a second operation position, which locates the mounting controller at the permission position.

In the agricultural work machine mounting device according to the present disclosure, the operation restriction part restricts the movement of the operation part located at the first operation position, and restricts the movement of the operation part located at the second operation position.

According to the present disclosure, the following effects can be achieved.

The present disclosure is realized such that the mounting part can be switched between the mounted state and the released state by merely operating the operation part. Therefore, the present disclosure can facilitate the mounting and detachment operations of the agricultural work machine. Additionally, the present disclosure can reduce the time required to perform the mounting operation of the agricultural work machine.

The present disclosure is realized such that the mounting part can maintain the mounted state or the released state even though a worker does not continuously apply force to the operation part. As a result, the present disclosure can fundamentally prevent the risk of accidents that may occur when the force applied to the operation part weakens or ceases by a mistake of the worker etc. Therefore, the present disclosure can achieve enhanced stability.

### BRIEF DESCRIPTION OF THE DRAWINGS

FIG. 1 is a schematic perspective view illustrating an example of an agricultural work vehicle to which an agricultural work machine mounting device according to the present disclosure can be applied.

FIGS. 2 and 3 are schematic side views of the agricultural work machine mounting device according to the present disclosure.

FIG. 4 is a schematic plan view illustrating a restriction hole, a permission hole, and a connection hole formed in a step plate of the agricultural work machine in relation to the agricultural work machine mounting device according to the present disclosure.

FIGS. 5 to 8 are schematic cross-sectional side views taken along line I-I of FIG. 4, depicting the operational relationship between an operation restriction part and an operation part according to a first embodiment.

FIGS. 9 to 11 are schematic plan views illustrating examples of the restriction hole, the permission hole, and the connection hole formed in the step plate of the agricultural work machine in relation to the agricultural work machine mounting device according to the present disclosure.

FIGS. 12 to 14 are schematic cross-sectional side views taken along line I-I of FIG. 4, depicting the operational relationship between an operation restriction part and an operation part according to a second embodiment.

FIGS. 15 to 17 are schematic cross-sectional side views taken along line I-I of FIG. 4, depicting the operational relationship between an operation restriction part and an operation part according to a third embodiment.

FIG. 18 is a schematic cross-sectional side view taken along line I-I of FIG. 4, depicting the operational relationship between an operation restriction part and an operation part according to a fourth embodiment.

FIG. 19 is a schematic plan view illustrating a restriction hole, a permission hole, and a connection hole formed in a step plate of the agricultural work machine in relation to an operation restriction part and an operation part according to a fifth embodiment.

FIGS. 20 and 21 are schematic cross-sectional side views taken along line II-II of FIG. 19, depicting the operational relationship between the operation restriction part and the operation part according to the fifth embodiment.

FIG. 22 is a schematic plan view illustrating a restriction hole, a permission hole, and a connection hole formed in a step plate of the agricultural work machine in relation to an operation restriction part and an operation part according to a sixth embodiment.

FIG. 23 is a schematic cross-sectional side view taken along line III-III of FIG. 22, depicting the operational relationship between the operation restriction part and the operation part according to the sixth embodiment.

FIG. 24 is a schematic plan view illustrating a state in which a locking mechanism is located at a pass position in relation to the operation restriction part and operation part according to the sixth embodiment.

### DETAILED DESCRIPTION

Hereinafter, an embodiment of an agricultural work machine mounting device according to the present disclosure will be described in detail with reference to the accompanying drawings.

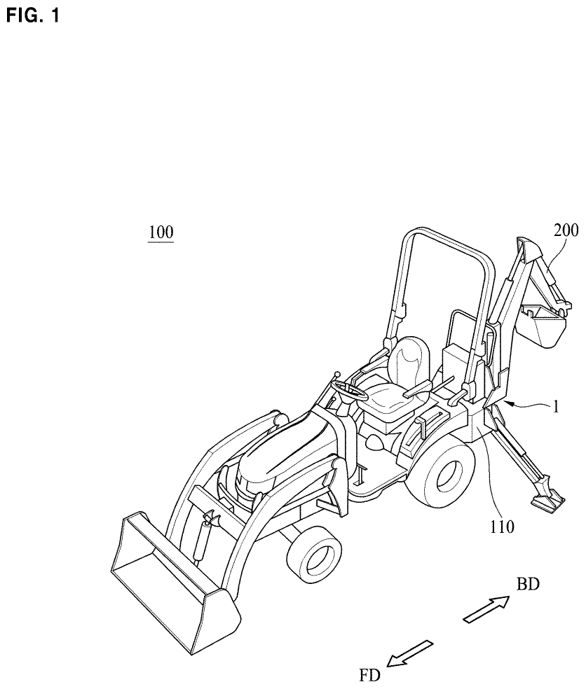

Referring to FIG. 1, the agricultural work machine mounting device 1 according to the present disclosure is for detachably mounting an agricultural work machine 200 to an agricultural work vehicle 100. The agricultural work vehicle 100 may be a tractor, a combine, a transplanter, etc. The agricultural work machine 200 may be a backhoe, a plow, a rotavator, etc. The agricultural work machine 200 can be mounted on the agricultural work vehicle 100 so as to be located at the rear (in the BD arrow direction) of the agricultural work vehicle 100.

The agricultural work machine mounting device 1 of the agricultural work vehicle according to the present disclosure can include a mounting part 2, a mounting controller 3, an operation part 4, and an operation restriction part 5.

Referring to FIGS. 1 to 3, the mounting part 2 is coupled to the agricultural work machine 200. The mounting part 2 can be detachably mounted on a mounting stand 110 of the agricultural work vehicle 100. Accordingly, the agricultural work machine 200 can be detachably mounted on the mounting stand 110 by the mounting part 2.

The mounting part 2 may include a first mounting mechanism 21, a second mounting mechanism 22, an elastic mechanism 23, and a restriction groove 24.

The first mounting mechanism 21 is rotatably coupled to the agricultural work machine 200. The first mounting mechanism 21 can be rotatably coupled to the side frame 210 of the agricultural work machine 200. The side frame 210 is a portion of the agricultural work machine 200 arranged to be erected vertically. The first mounting mechanism 21 may include a first mounting groove 211. The first mounting groove 211 can be configured as a groove facing the second mounting mechanism 22.

The second mounting mechanism 22 is rotatably coupled to the agricultural work machine 200. The second mounting mechanism 22 can be rotatably coupled to the side frame 210. The second mounting mechanism 22 may include a second mounting groove 221. The second mounting groove 221 can be configured as a groove facing the first mounting groove 211.

The second mounting mechanism 22 and the first mounting mechanism 21 can rotate in opposite directions around respective rotational shafts 21a and 22a.

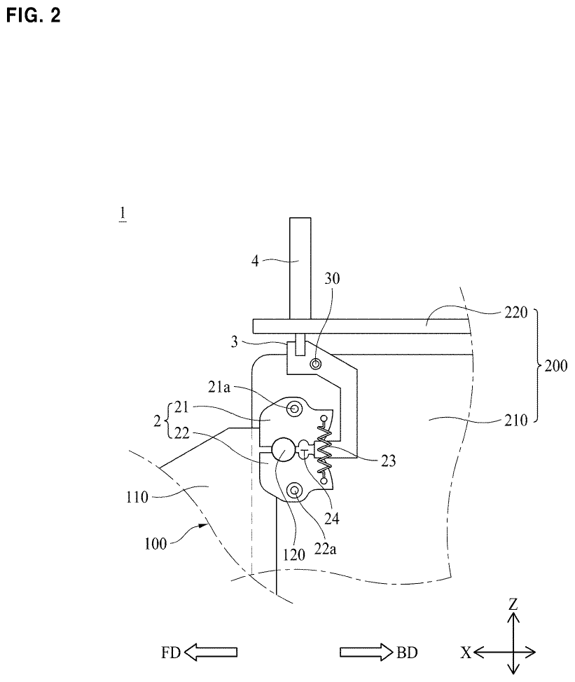

As illustrated in FIG. 2, when the second mounting mechanism 22 and the first mounting mechanism 21 rotate in the direction that brings the second mounting groove 221 and the first mounting groove 211 closer together, the mounting part 2 can be mounted on the mounting stand 110. In this case, the mounting part 2 can maintain the mounted state on the mounting stand 110 by supporting a mounting protrusion 120 of the mounting stand 110 inserted into the second mounting groove 221 and the first mounting groove 211. As described above, when the second mounting mechanism 22 and the first mounting mechanism 21 rotate in the direction that brings the second mounting groove 221 and the first mounting groove 211 closer together, the mounting part 2 can be switched to the mounted state.

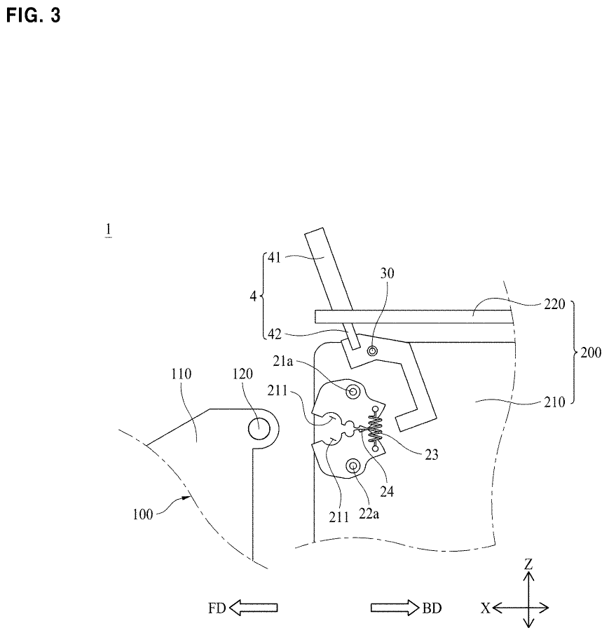

As illustrated in FIG. 3, when the second mounting mechanism 22 and the first mounting mechanism 21 rotate in the direction that the second mounting groove 221 and the first mounting groove 211 are spaced apart, the mounting part 2 becomes unobstructed by the mounting protrusion 120 of the mounting stand 110. I this case, if the mounting part 2 is in the mounted state on the mounting stand 110, the mounting part 2 can be switched to a detachable state from the mounting stand 110. If the mounting part 2 is not mounted on the mounting stand 110, the mounting part 2 can be switched to a state in which the mounting part 2 can be mounted on the mounting stand 110. As described above, when the second mounting mechanism 22 and the first mounting mechanism 21 rotate in the direction that the second mounting groove 221 and the first mounting groove 211 are spaced apart, the mounting part 2 can be switched to a released state.

The elastic mechanism 23 provides elasticity to the first mounting mechanism 21 and the second mounting mechanism 22 in the direction that the first mounting groove 211 and the second mounting groove 221 are spaced apart. The elastic mechanism 23 can be coupled to each of the first mounting mechanism 21 and the second mounting mechanism 22. One side of the elastic mechanism 23 can be coupled to the first mounting mechanism 21 behind (in the BD arrow direction) the rotational shaft 21a of the first mounting mechanism 21. The other side of the elastic mechanism 23 can be coupled to the second mounting mechanism 22 behind (in the BD arrow direction) the rotational shaft 22a of the second mounting mechanism 22. Accordingly, when an external force for restricting movement is not applied to the first mounting mechanism 21 and the second mounting mechanism 22, the first mounting mechanism 21 and the second mounting mechanism 22 can rotate in the direction that the first mounting groove 211 and the second mounting groove 221 are spaced apart due to the elasticity of the elastic mechanism 23. In this case, referring to FIG. 3, the first mounting mechanism 21 can rotate in the clockwise direction around the rotational shaft 21a of the first mounting mechanism 21, and the second mounting mechanism 22 can rotate in the counterclockwise direction around the rotational shaft 22a of the second mounting mechanism 2. The elastic mechanism 23 can be configured as a spring.

The restriction groove 24 is intended for the insertion of the mounting controller 3. When the mounting controller 3 is inserted into the restriction groove 24 in a state in which the mounting part 2 is in the mounted state, the mounting controller 3 can restrict the movement of the first mounting mechanism 21 and the second mounting mechanism 22. In this case, the mounting controller 3 inserted into the restriction groove 24 supports the first mounting mechanism 21 and the second mounting mechanism 22, thereby maintaining the mounting part 2 in the mounted state. When the mounting controller 3 is moved away from the restriction groove 24, the mounting controller 3 can allow the movement of the first mounting mechanism 21 and the second mounting mechanism 22, enabling the mounting part 2 to switch to the released state. In this case, the first mounting mechanism 21 and the second mounting mechanism 22 can rotate due to the elastic force of the elastic mechanism 23. The restriction groove 24 can be formed in each of the first mounting mechanism 21 and the second mounting mechanism 22. The first restriction groove formed in the first mounting mechanism 21 can be positioned behind (in the BD arrow direction) relative to the rotational shaft 21a of the first mounting mechanism 21. The second restriction groove formed in the second mounting mechanism 22 can be positioned behind (in the BD arrow direction) relative to the rotational shaft 22a of the second mounting mechanism 22.

Referring to FIGS. 1 to 3, the mounting controller 3 is intended to control the movement of the mounting part 2. The mounting controller 3 can be coupled to the agricultural work machine 200. The mounting controller 3 can be rotatably coupled to the side frame 210 of the agricultural work machine 200. The mounting controller 3 can rotate between a restriction position and a permission position. When the mounting controller 3 is in the restriction position, as illustrated in FIG. 2, the mounting controller 3 can be inserted into the restriction groove 24 to restrict the movement of the first mounting mechanism 21 and the second mounting mechanism 22. In this case, as the mounting controller 3 is inserted into the restriction groove 24, the mounting part 2 can be maintained in the mounted state. When the mounting controller 3 is in the permission position, as illustrated in FIG. 3, the mounting controller 3 can be moved away from the restriction groove 24 to allow the movement of the first mounting mechanism 21 and the second mounting mechanism 22. In this case, the first mounting mechanism 21 and the second mounting mechanism 22 can rotate due to the elastic force of the elastic mechanism 23, enabling the mounting part 2 to switch to the released state. A rotational shaft 30 of the mounting controller 3, the rotational shaft 21a of the first mounting mechanism 21, and the rotational shaft 22a of the second mounting mechanism 22 can be arranged parallel to each other. The mounting controller 3 can rotate between the restriction position and the permission position in response to the movement of the operation part 4.

Referring to FIGS. 1 to 3, the operation part 4 is for moving the mounting controller 3. The operation part 4 can be coupled to the mounting controller 3. Accordingly, the movement of the operation part 4 allows the mounting controller 3 to move between the restriction position and the permission position. The operation part 4 can move between a first operation position and a second operation position. When the operation part 4 is in the first operation position, as illustrated in FIG. 2, the mounting controller 3 is located at the restriction position, thereby maintaining the mounting part 2 in the mounted state. When the operation part 4 is located at the second operation position, as illustrated in FIG. 3, the mounting controller 3 is located at the permission position, thereby allowing the mounting part 2 to be switched to the released state.

Accordingly, the agricultural work machine mounting device 1 according to the present disclosure moves the operation part 4 to the second operation position to switch the mounting part 2 into the released state, positions the mounting protrusion 120 between the first mounting mechanism 21 and the second mounting mechanism 22, and maintains the mounting part 2 in the mounted state just by moving the operation part 4 to the first operation position, thereby enabling the the agricultural work machine 200 to be mounted on the agricultural work vehicle 100. Furthermore, the agricultural work machine mounting device 1 can switch the mounting part 2 into the released state just by moving the operation part 4 to the second operation position in the state in which the mounting part 2 is mounted on the agricultural work vehicle 100, thereby enabling the agricultural work machine 200 to be in a detachable state from the agricultural work vehicle 100.

As described above, the agricultural work machine mounting device 1 according to the present disclosure can switch the mounting part 2 between the mounted state and the released state just by moving the operation part 4 between the first operation position and the second operation position. Compared to the the conventional technology that uses the overlap of holes and the insertion and removal of pins for the mounting and detachment of the agricultural work machine 200, the agricultural work machine mounting device according to the present disclosure significantly enhances the ease in mounting and detachment operations of the agricultural work machine 200.

Additionally, according to the conventional art, in the process of mounting the agricultural work machine 200, the holes must be accurately overlapped for the insertion of the pins, requiring the agricultural work machine 200 and the agricultural work vehicle 100 to be precisely aligned. On the other hand, the agricultural work machine mounting device 1 according to the present disclosure allows for the mounting of the agricultural work machine 200 by simply positioning the mounting protrusion 120 between the first mounting mechanism 21 and the second mounting mechanism 22 in the state in which the mounting part 2 is in the released state. Thus, compared to the conventional art, the agricultural work machine mounting device 1 according to the present disclosure can perform the mounting operation without precisely aligning the relative positions of the agricultural work vehicle 100 and the agricultural work machine 200. Therefore, the agricultural work machine mounting device 1 according to the present disclosure not only enhances the ease of mounting the agricultural work machine 200 but also reduces the time required to perform the mounting operation.

A lower portion of the operation part 4 can be coupled to the mounting controller 3. An upper portion of the operation part 4 can protrude upward from a step plate 220 of the agricultural work machine 200. The step plate 220 is where a worker's foot is positioned. The step plate 220 can be located above the side frame 210. The worker can operate the upper portion of the operation part 4, which protrudes above the step plate 220, to move the operation part 4 between the first operation position and the second operation position. A portion located between the lower portion and the upper portion of the operation part 4 can be inserted into the step plate 220. Accordingly, the agricultural work machine mounting device 1 according to the present disclosure can enhance the stability of the movement of the mounting part 2 and the mounting controller 3 since the movement of the mounting part 2 and the mounting controller 3 for mounting and detachment of the agricultural work machine 200 is carried out beneath the step plate 220. Additionally, because the operation of the operation part 4 can be performed from above the step plate 220, the agricultural work machine mounting device 1 according to the present disclosure can enhance the ease in operation of the operation part 4.

Referring to FIGS. 1 to 3, the operation restriction part 5 is intended to restrict the movement of the operation part 4. The operation restriction part 5 can restrict the movement of the operation part 4 located at the first operation position. Accordingly, the operation restriction part 5 can maintain the mounting controller 3 in the restriction position by restricting the movement of the operation part 4, thereby maintaining the mounting part 2 in the mounted state. Therefore, the agricultural work machine mounting device 1 according to the present disclosure can maintain the mounting part 2 in the mounted state without the worker continuously applying force to the operation part 4 by using the operation restriction part 5 to maintain the operation part 4 in the first operation position. The operation restriction part 5 can also restrict the movement of the operation part 4 located at the second operation position. Accordingly, the operation restriction part 5 can maintain the mounting part 2 in the released state by restricting the movement of the mounting controller 3 located at the permission position through movement restriction of the operation part 4. Therefore, the agricultural work machine mounting device 1 according to the present disclosure can maintain the mounting part 2 in the released state by maintaining the operation part 4 in the second operation position using the operation restriction part 5 even if the worker does not continuously apply force to the operation part 4.

As described, the agricultural work machine mounting device 1 according to the present disclosure can be configured to maintain the mounting part 2 in the mounted state or the released state by maintaining the operation part 4 in the first operation position or the second operation position using the operation restriction part 5 even if the worker does not continuously apply force to the operation part 4. Thus, the agricultural work machine mounting device 1 according to the present disclosure can achieve the following effects.

First, in a comparative example where the mounting part 2 can be maintained in the mounted state and the released state only when the worker continuously applies force to the operation part 4, there is a risk of accidents when the force applied to the operation part 4 by the worker weakens or ceases due to mistakes or other reasons.

On the other hand, the agricultural work machine mounting device 1 according to the present disclosure does not require the worker to continuously apply force to the operation part 4, thereby fundamentally preventing the risk of accidents that could occur when the force applied to the operation part 4 by the worker weakens or ceases. Therefore, the agricultural work machine mounting device 1 according to the present disclosure can enhance stability.

The operation restriction part 5 can be formed on the step plate 220. Accordingly, compared to a comparative example where the operation restriction part 5 is formed on the side frame 210, the agricultural work machine mounting device 1 according to the present disclosure can achieve additional functional effects as follows.

First, in the comparative example, since the operation restriction part 5 is formed on the side frame 210, the operation part 4 can be positioned beneath the step plate 220. Consequently, in the comparative example, the worker must disembark from the agricultural work vehicle 100 or the agricultural work machine 200 to operate the operation part 4, and cannot operate the operation part 4 while seated on the agricultural work vehicle 100 or the agricultural work machine 200.

Meanwhile, in the embodiment of the present disclosure, since the operation restriction part 5 is formed on the step plate 220, the operation part 4 can be positioned to protrude above the step plate 220. Thus, in the embodiment of the present disclosure, the worker can operate the operation part 4 while seating on the agricultural work vehicle 100 or the agricultural work machine 200. Therefore, compared to the comparative example, the present embodiment enhances the ease of operating the operation part 4, thereby further improving the ease of mounting and detaching the agricultural work machine 200.

Additionally, in the present embodiment, the operation restriction part 5 is formed on the step plate 220, and the mounting part 2 and the mounting controller 3 can be configured to be coupled to the side frame 210. Accordingly, in the present embodiment, the operation part 4 can protrude above the step plate 220 and the mounting part 2 and the mounting controller 3 can be moved beneath the step plate 220. Thus, the present embodiment can improve the ease of mounting and detaching the agricultural work machine 200 and enhance the stability of the movement of the mounting part 2 and the mounting controller 3.

Hereinafter, the agricultural work machine mounting device 1 according to the present disclosure can include various embodiments concerning the operation restriction part 5 and the operation part 4. Hereinafter, detailed descriptions of the embodiments of the operation restriction part 5 and the operation part 4 will be provided with reference to the attached drawings.

### First Embodiment

According to a first embodiment, the operation restriction part 5 and the operation part 4 can be realized as follows.

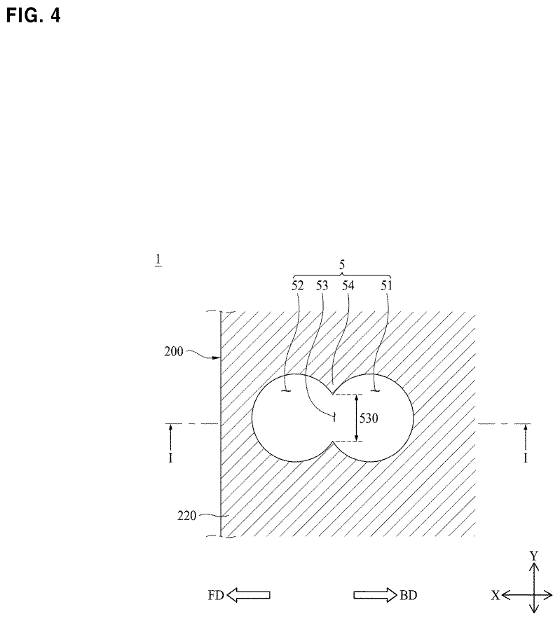

Referring to FIGS. 4 to 11, the operation restriction part 5 may include a restriction hole 51, a permission hole 52, a connection hole 53, and a protrusion member 54.

The restriction hole 51 is formed in the step plate 220. The restriction hole 51 can be formed to pass through the step plate 220. When the operation part 4 is inserted into the restriction hole 51, the operation part 4 can be located at the first operation position.

The permission hole 52 is formed in the step plate 220. The permission hole 52 can be formed to pass through the step plate 220. When the operation part 4 is inserted into the permission hole 52, the operation part 4 can be located at the second operation position.

The permission hole 52 and the restriction hole 51 can be arranged parallel in a first axial direction (X-axis direction). Based on the first axial direction (X-axis direction), the permission hole 52 can be positioned forward (in the FD arrow direction) relative to the restriction hole 51. In this case, the restriction hole 51 can be positioned behind (in the BD arrow direction) relative to the permission hole 52.

The connection hole 53 is formed in the step plate 220. The connection hole 53 can be formed to pass through the step plate 220. The connection hole 53 can be positioned between the restriction hole 51 and the permission hole 52. When the operation part 4 moves between the first operation position and the second operation position, the operation part 4 can move between the restriction hole 51 and the permission hole 52 via the connection hole 53.

The protrusion member 54 protrudes towards the connection hole 53. The protrusion member 54 extends from the step plate 220 towards the connection hole 53, thereby narrowing a width 530 (illustrated in FIG. 4) of: the connection hole 53. Consequently, the protrusion member 54 supports the operation part 4 inserted into the restriction hole 51, thereby restricting the movement of the operation part 4 located at the first operation position. The protrusion member 54 also supports the operation part 4 inserted into the permission hole 52, thereby restricting the movement of the operation part 4 located at the second operation position. As described above, in the first embodiment, the agricultural work machine mounting device 1 according to the present disclosure can maintain the operation part 4 in the first operation position or the second operation position using the protrusion member 54 even if the worker does not continuously apply force to the operation part 4, thereby maintaining the mounting part 2 in the mounted state or the released state. The width 530 of the connection hole 53 is based on the second axial direction (Y-axis direction). The first axial direction (X-axis direction) and the second axial direction (Y-axis direction) are arranged perpendicularly to each other.

Referring to FIGS. 4 to 11, the operation part 4 may include an operation member 41 and a coupling member 42.

The operation member 41 is coupled above the coupling member 42. The operation member 41 may protrude upward from the coupling member 42. An upper portion of the operation member 41 may protrude above the step plate 220. The worker can operate the operation member 41 to move the operation part 4 between the first operation position and the second operation position. The operation member 41 can be formed with a horizontal cross-sectional area larger than that of the connection hole 53. The horizontal cross-sectional area refers to the cross-sectional area based on the horizontal plane where a first axial direction (X-axis direction) and a second axial direction (Y-axis direction) are arranged. In this case, based on the second axial direction (Y-axis direction), the width 530 of the connection hole 53 is narrowed by the protrusion member 54, hence the width 530 of the connection hole 53 can be shorter than the width of the operation member 41 due to the protrusion member 54. Therefore, the operation member 41 is configured not to pass through the connection hole 53. Additionally, the operation member 41 can be supported by the protrusion member 54 at both the first operation position where the operation member is inserted into the restriction hole 51 and the second operation position where the operation member is inserted into the permission hole 52, thereby restricting the movement. The operation member 41 can be formed with a horizontal cross-sectional area equal to that of each of the restriction hole 51 and the permission hole 52. Accordingly, the operation member 41 can also be formed with a horizontal cross-sectional area smaller than that of each of the restriction hole 51 and the permission hole 52. Therefore, the operation member 41 can be located at the first operation position by being inserted into the restriction hole 51 and located at the second operation position by being inserted into the permission hole 52.

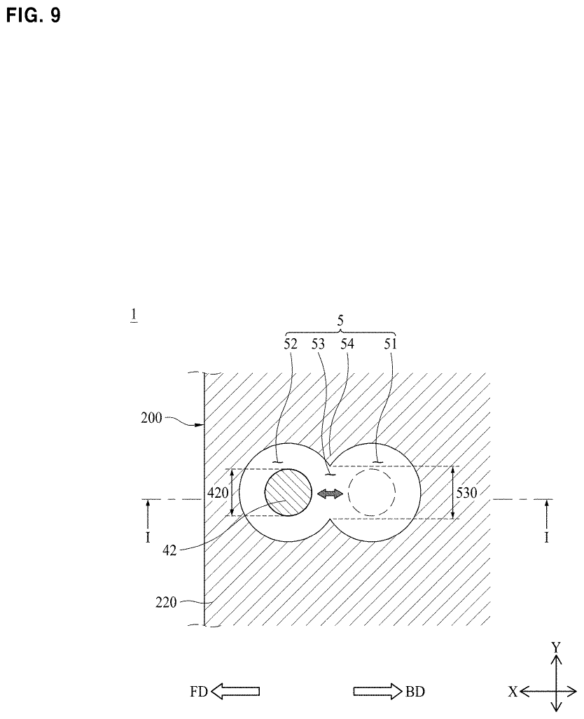

The coupling member 42 is coupled to the mounting controller 3. The operation member 41 can be coupled to the coupling member 42. Accordingly, as the operation member 41 moves between the first operation position and the second operation position, the coupling member 42 can also move, and through the coupling member 42, the mounting controller 3 can move between the restriction position and the permission position. Consequently, the mounting part 2 can be switched between the mounted state and the released state. The coupling member 42 can be formed with a horizontal cross-sectional area smaller than that of the connection hole 53. Therefore, as the operation member 41 moves between the first and second operation positions, the coupling member 42 can pass through the connection hole 53 to move. In this case, based on the second axial direction (Y-axis direction), a width 420 (illustrated in FIG. 9) of the coupling member 42 can be formed shorter than the width 530 of the connection hole 53. Accordingly, the coupling member 42 can pass through the connection hole 53 without interference from the protrusion member 54. The coupling member 42 and the operation member 41 can be formed integrally. Alternatively, the coupling member 42 and the operation member 41 can be manufactured separately and then joined using a fastener such as a bolt.

The operation part 4 may include a lifting hole 43.

The lifting hole 43 is formed in the coupling member 42. The lifting hole 43 may be formed to pass through the coupling member 42. A connection member 31 of the mounting controller 3 can be inserted into the lifting hole 43. The coupling member 42 can be connected to the mounting controller 3 through the connection member 31 inserted into the lifting hole 43. The coupling member 42 can be liftably coupled to the mounting controller 3 through the lifting hole 43. In this case, based on the vertical direction (Z-axis direction), the lifting hole 43 can be formed as a long hole with a length longer than that of the connection member 31. That is, the lifting hole 43 can be formed with a vertical cross-sectional area larger than that of the connection member 31. The vertical direction (Z-axis direction) is perpendicular to each of the first axial direction (X-axis direction) and the second axial direction (Y-axis direction).

As being liftably coupled to the mounting controller 3 through the lifting hole 43, the coupling member 42 can be moved up and down together with the operation member 41 or the coupling member 42, thereby being inserted into or spaced from the step plate 220. Consequently, the operation part 4 can move the mounting controller 3 between the restriction position and the permission position while moving between the first operation position and the second operation position, and can be limited in movement by being supported by the operation restriction part 5 at each of the first operation position and the second operation position. The above will be described in detail as follows.

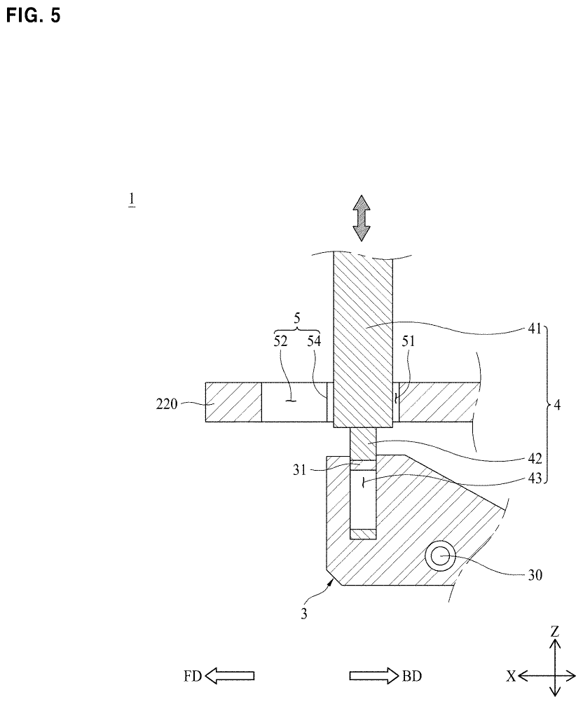

First, as illustrated in FIG. 5, when the operation part 4 is located at the first operation position, the operation member 41 can be lowered together with the coupling member 42 and inserted into the step plate 220. In this case, the operation member 41 can be inserted into the restriction hole 51. Accordingly, the operation member 41 is supported by the protrusion member 54, so the operation part 4 can be firmly maintained in the first operation position. Therefore, the mounting controller 3 can be maintained in the restriction position, and the mounting part 2 can be maintained in the mounted state. FIG. 5 illustrates that when the operation part 4 is located at the first operation position, the operation part 4 is erected parallel to the vertical direction (Z-axis direction), but the operation part is not limited thereto, and can be erected to be inclined relative to the vertical direction (Z-axis direction) at the first operation position.

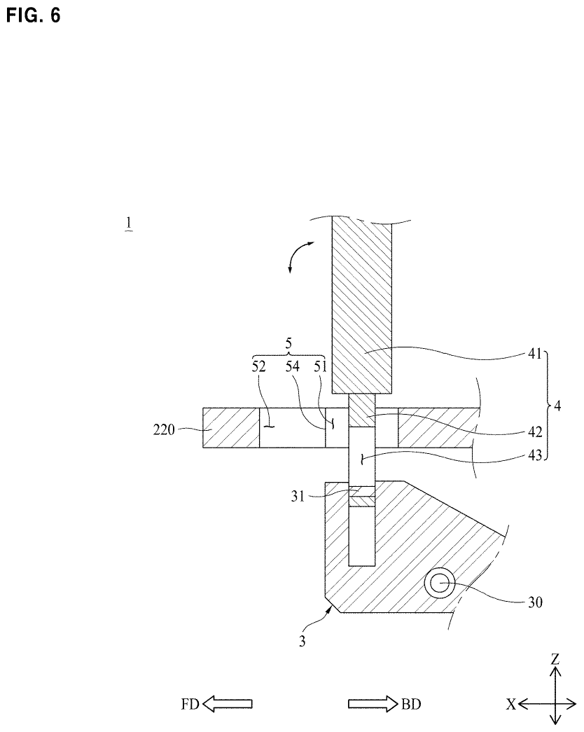

Next, as illustrated in FIG. 6, when the operation member 41 is raised together with the coupling member 42 through the lifting hole 43, the operation member 41 can be spaced upward from the step plate 220. Consequently, the operation member 41 is separated from the restriction hole 51, and so, is no longer supported by the protrusion member 54. Therefore, the operation part 4 can be switched into a state in which the operation part can move from the first operation position to the second operation position.

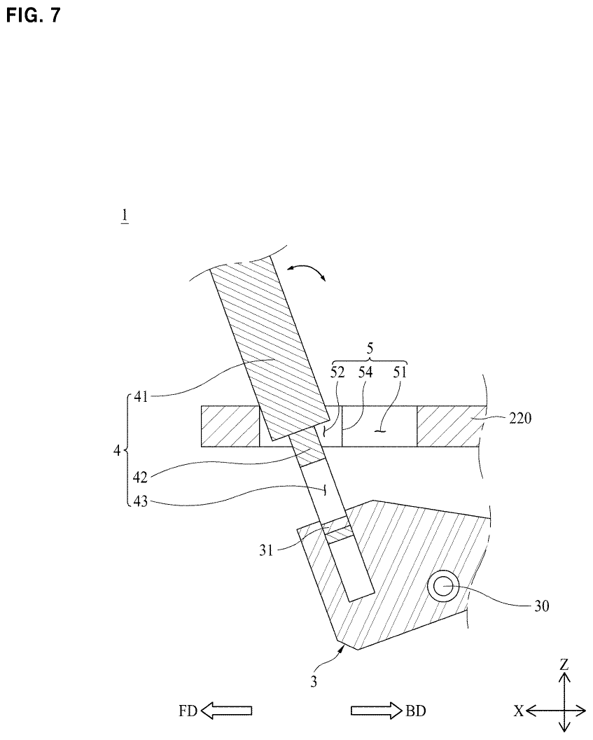

Next, as illustrated in FIG. 7, when the operation member 41 moves forward (in the FD arrow direction) and the operation part 4 is moved from the first operation position towards the second operation position, the operation part 4 and the mounting controller 3 can rotate around the rotational shaft 30 of the mounting controller 3. Referring to FIG. 7, the operation part 4 and the mounting controller 3 can rotate in the counterclockwise direction around the rotational shaft 30 of the mounting controller 3. Accordingly, the mounting controller 3 can move from the restriction position to the permitted position. In this case, the mounting part 2 can be switched from the mounted state into the released state.

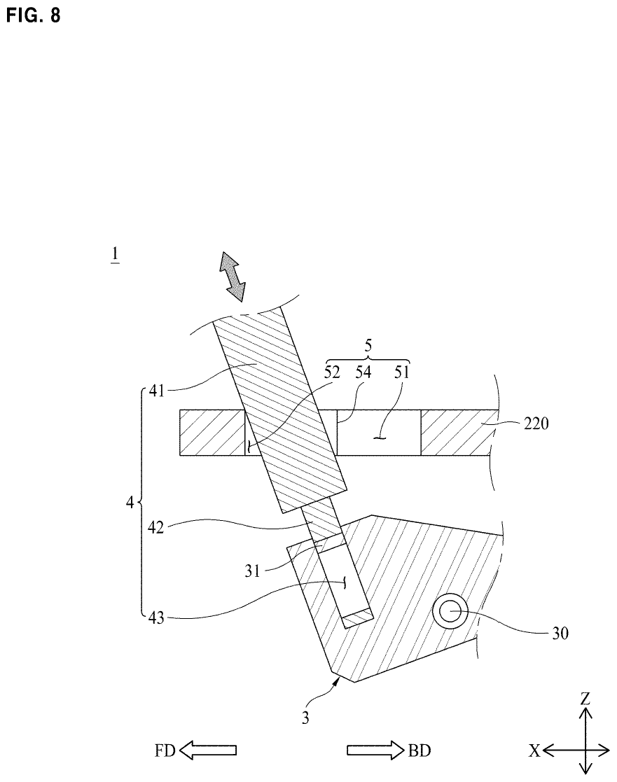

Next, as illustrated in FIG. 8, when the operation member 41 descends together with the coupling member 42 through the lifting hole 43, the operation member 41 can be inserted into the step plate 220. In this case, the operation member 41 can be inserted into the permission hole 52. Accordingly, the operation member 41 is supported by the protrusion member 54, so the operation part 4 can be securely maintained in the second operation position. Therefore, the mounting controller 3 can be maintained in the permission position, and the mounting part 2 can be maintained in the released state. FIG. 8 illustrates that when the operation part 4 is located at the second operation position, the operation part 4 is erected to be inclined relative to the vertical direction (Z-axis direction), but is not limited thereto, and can also be erected parallel to the vertical direction (Z-axis direction) at the second operation position. Although not illustrated, the operation part 4 may also be erected to be inclined relative to the vertical direction (Z-axis direction) at each of the second operation position and the first operation position.

As described above, by using the ascent and descent of the operation member 41 and the coupling member 42 through the lifting hole 43, the operation part 4 moves from the first operation position to the second operation position and is maintained in the second operation position, such that the mounting controller 3 can move from the restriction position to the permission position and can be maintained in the permission position, and the mounting part 2 can be switched from the mounted state into the released state and maintained in the released state. Since the process where the operation part 4 moves from the second operation position to the first operation position and is maintained in the first operation position, the mounting controller 3 moves from the permission position to the restriction position, and the mounting part 2 is switched from the released state to the mounted state and maintained in the mounted state can be achieved by reversely performing the aforementioned process, a detailed description thereof will be omitted.

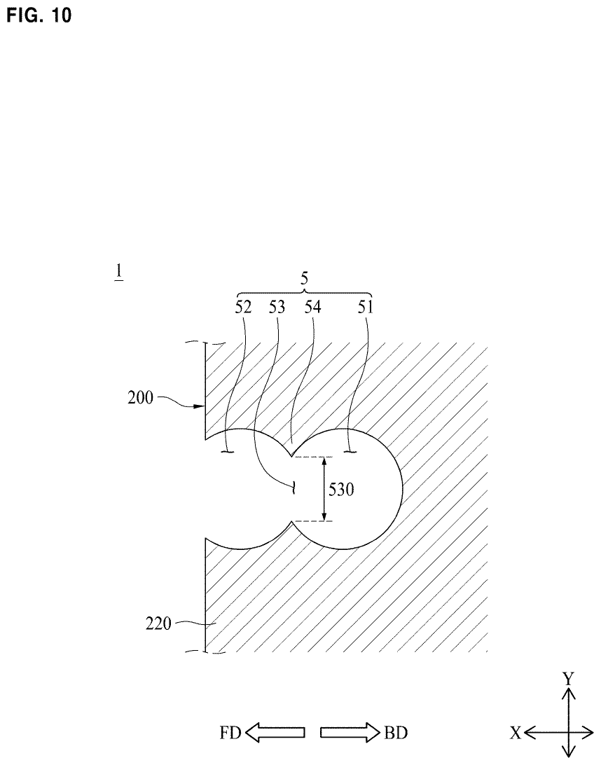

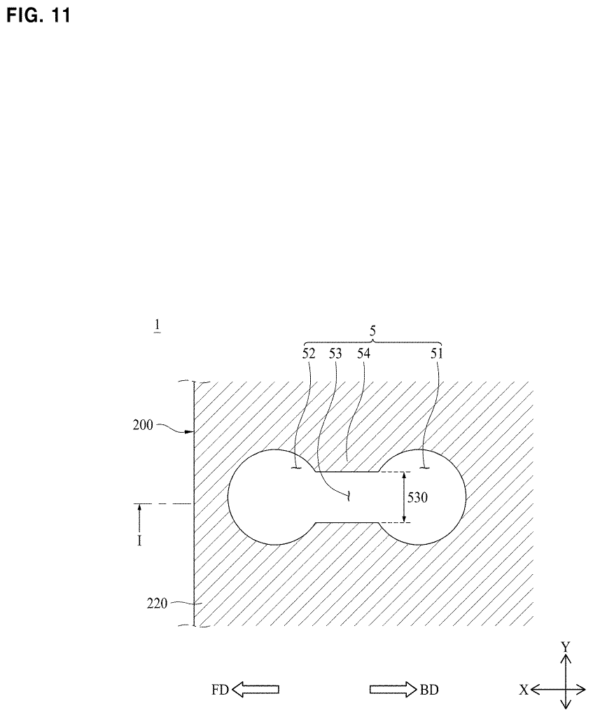

Meanwhile, as illustrated in FIGS. 4 and 9, the permission hole 52 can be located at a location spaced backwards (in the BD arrow direction) from the front face of the step plate 220. In this case, the permission hole 52 and the restriction hole 51 can be formed to partially overlap each other, while forming a horizontal cross-section with a circular curvature. For example, the permission hole 52, the restriction hole 51, and the connection hole 53 can be formed in the shape of the numeral eight. As illustrated in FIG. 10, the permission hole 52 can also be formed by penetrating the front face of the step plate 220. In this case, when being located at the second operation position, the operation part 4 cannot be supported by the step plate 220 towards the front (in the FD arrow direction), but when the mounting controller 3 is supported by the step plate 220 or by a rear plate (not illustrated) coupled to the step plate 220, the operation part 4 can be limited from moving further forward (in the FD arrow direction) at the second operation position. As illustrated in FIG. 11, the restriction hole 51 and the permission hole 52 are arranged to be spaced apart from each other in the first axial direction (X-axis direction), and the connection hole 53 can be formed to be elongated in the first axial direction (X-axis direction) to communicate with each of the restriction hole 51 and the permission hole 52. In this case, the protrusion member 54 can be positioned between the restriction hole 51 and the permission hole 52 based on the first axial direction (X-axis direction). The protrusion member 54 may be positioned outside the connection hole 53 based on the second axial direction (Y-axis direction).

### Second Embodiment

According to a second embodiment, the operation restriction part 5 and the operation part 4 can be realized as follows.

Referring to FIGS. 4 to 14, the operation restriction part 5 can be configured to be roughly identical to the description of the first embodiment, so a detailed description of the operation restriction part will be omitted.

Referring to FIGS. 4 to 14, compared to the first embodiment, the operation part 4 of the second embodiment has a difference in that the operation part 4 does not have the lifting hole 43. Instead of the lifting hole 43, the operation part 4 according to the second embodiment can be configured in such a way that the operation member 41 is liftably coupled to the coupling member 42. Since the operation part 4 can be configured to be roughly identical to that of the first embodiment except being liftably coupled to the coupling member 42, hereinafter, differences between the second embodiment and the first embodiment will be described.

The operation member 41 can be coupled to the coupling member 42 to move up and down. The operation member 41 can be fastened to the coupling member 42 via threads or similar means to be liftably coupled to the coupling member 42. The operation member 41 can be liftably coupled to the coupling member 42 by using protrusions that are inserted into any one of a plurality of grooves formed to be spaced apart in the vertical direction (Z-axis direction).

The coupling member 42 can be coupled to the mounting controller 3 via the connection member 31. In this case, the coupling member 42 can be coupled to the mounting controller 3 not to move up and down. Consequently, in the state in which the coupling member 42 does not move up and down, the operation member 41 ascends relative to the coupling member 42 to be spaced apart from the step plate 220 upwards, and descends relative to the coupling member 42 to be inserted into the step plate 220. Therefore, the operation part 4 can move between the first operation position and the second operation position, and thus move the mounting controller 3 between the restriction position and the permission position, and can also be supported by the operation restriction part 5 at each of the first and second operation positions, so as to be limited in movement. The above will be described in detail as follows.

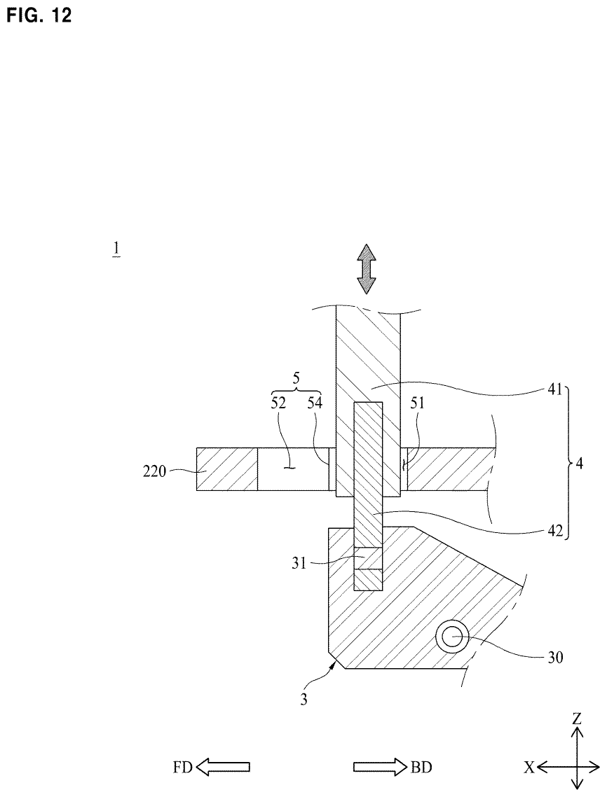

First, as illustrated in FIG. 12, when the operation part 4 is located at the first operation position, the operation member 41 can descend relative to the coupling member 42 and be inserted into the step plate 220. In this case, the operation member 41 can be inserted into the restriction hole 51. Consequently, the operation member 41 is supported by the protrusion member 54, so the operation part 4 can be securely maintained in the first operation position. Thus, the mounting controller 3 can be maintained in the restriction position, and the mounting part 2 can be maintained in the mounted state.

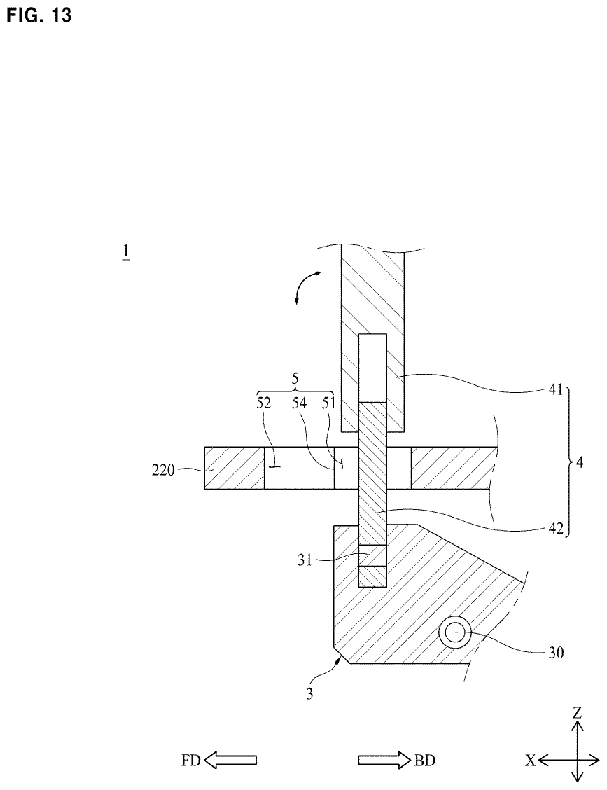

Next, as illustrated in FIG. 13, when the operation member 41 ascends relative to the coupling member 42, the operation member 41 can be spaced upward from the step plate 220. Consequently, the operation member 41 is separated from the restriction hole 51 and is no longer supported by the protrusion member 54. Therefore, the operation part 4 can be switched into a state in which the operation part 4 can move from the first operation position to the second operation position.

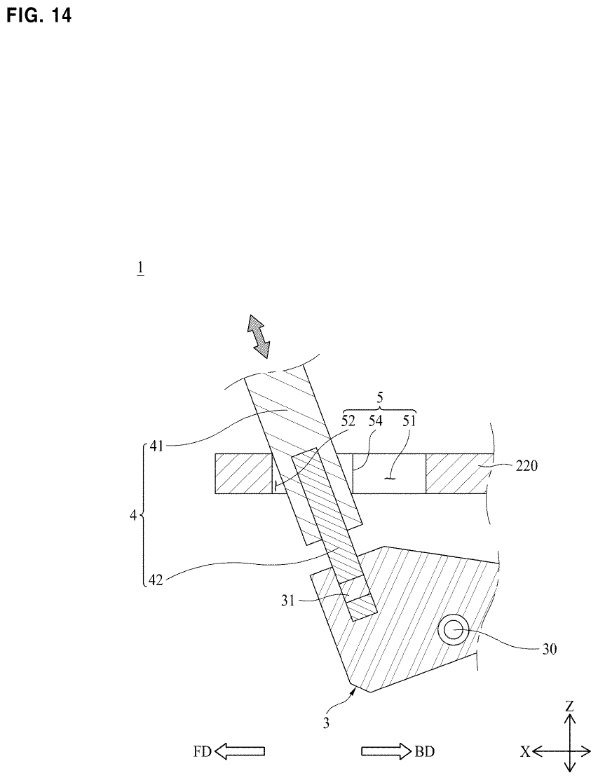

Next, as illustrated in FIG. 14, after the operation member 41 moves forward (in the FD arrow direction) and the operation part 4 moves from the first operation position towards the second operation position, the operation member 41 can descend relative to the coupling member 42 to be inserted into the step plate 220. In this case, the operation member 41 can be inserted into the permission hole 52. Accordingly, the operation member 41 is supported by the protrusion member 54, and the operation part 4 can be firmly maintained in the second operation position. Consequently, the mounting controller 3 can move from the restriction position to the permission position and be maintained in the permission position, and the mounting part 2 can be switched from the mounted state into the released state and be maintained in the released state.

As described above, using the ascent and descent of the operation member 41 relative to the coupling member 42, the operation part 4 moves from the first operation position to the second operation position and is maintained in the second operation position. So, the mounting controller 3 can be moved from the restriction position to the permission position and be maintained in the permission position, and the mounting part 2 can be switched from the mounted state into the released state and be maintained in the released state. Since the process where the operation part 4 moves from the second operation position to the first operation position and is maintained in the first operation position, the mounting controller 3 moves from the permission position to the restriction position, and the mounting part 2 is switched from the released state to the mounted state and maintained in the mounted state can be achieved by reversely performing the aforementioned process, a detailed description thereof will be omitted.

### Third Embodiment

According to a third embodiment, the operation restriction part 5 and the operation part 4 can be realized as follows.

Referring to FIGS. 4 to 17, the operation restriction part 5 can be realized to be roughly identical to the description of the first embodiment, so a detailed description of the operation restriction part will be omitted.

Referring to FIGS. 4 to 17, compared to the first embodiment, the operation part 4 of the second embodiment has a difference in that the operation part 4 does not have the lifting hole 43. Instead of the lifting hole 43, the operation part 4 according to the third embodiment can be configured in such a way that the coupling member 42 is liftably coupled to the mounting controller 3 through screw coupling. Since the operation part 4 can be configured to be roughly identical to that of the first embodiment except that the coupling member 42 is liftably coupled to the mounting controller 3 through screw coupling instead of the lifting hole 43, hereinafter, differences between the second embodiment and the first embodiment will be described.

The operation member 41 can be coupled to the coupling member 42. The operation member 41 and the coupling member 42 can ascend and descend together.

The coupling member 42 can be liftably coupled to the mounting controller 3 through screw coupling. In this case, a portion of the coupling member 42 inserted into the mounting controller 3 may have an external thread formed on the outer surface thereof, and a portion of the mounting controller 3 into which the coupling member 42 is inserted may have an internal thread formed on the inner surface thereof. When the coupling member 42 is rotated in the direction to be unfastened from the mounting controller 3, the coupling member 42 can ascend relative to the mounting controller 3. In this case, as the coupling member 42 ascends, the operation member 41 can also ascend together. Conversely, when the coupling member 42 is rotated in the direction to be fastened to the mounting controller 3, the coupling member 42 can descend relative to the mounting controller 3. As the coupling member 42 descends, the operation member 41 can descend together. The rotation of the coupling member 42 can occur as rotational force is applied to the operation member 41. In this case, when the worker rotates the operation member 41 in the clockwise direction and in the counterclockwise direction, the coupling member 42 and the operation member 41 can be moved up and down relative to the mounting controller 3.

As described above, using the screw coupling between the coupling member 42 and the mounting controller 3, the operation member 41 can be elevated together with the coupling member 42 to be spaced upward from the step plate 220, and can be lowered together with the coupling member 42 to be inserted into the step plate 220. Therefore, the operation part 4 can not only move the mounting controller 3 between the restriction position and the permission position while moving between the first operation position and the second operation position, but also be limited in movement by being supported by the operation restriction part 5 at each of the first operation position and the second operation position. The above will be described in detail as follows.

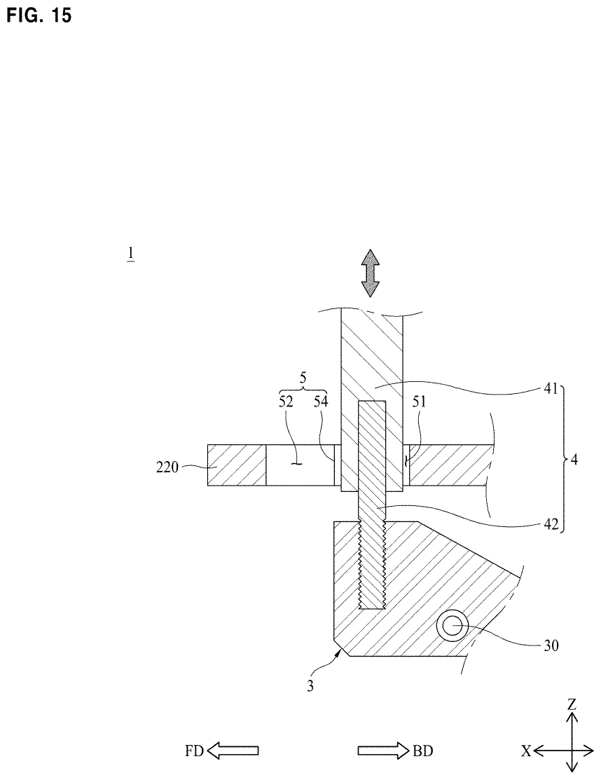

First, as illustrated in FIG. 15, when the operation part 4 is located at the first operation position, the operation member 41 can be lowered together with the coupling member 42 to be inserted into the step plate 220. In this case, the operation member 41 can be inserted into the restriction hole 51. Accordingly, by being supported by the protrusion member 54, the operation part 4 can be firmly maintained in the first operation position. Therefore, the mounting controller 3 can be maintained in the restriction position, and the mounting part 2 can be maintained in the mounted state.

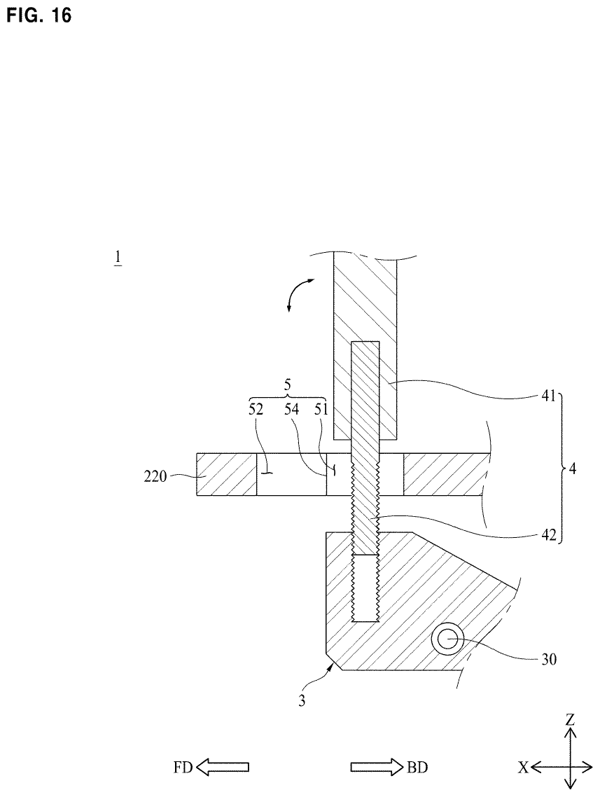

Next, as illustrated in FIG. 16, when the coupling member 42 ascends relative to the mounting controller 3 and the operation member 41 ascends together with the coupling member 42, the operation member 41 can be spaced upward from the step plate 220. Accordingly, the operation member 41 can be separated from the restriction hole 51 and thus will be no longer supported by the protrusion member 54. Therefore, the operation part 4 can be switched into a state in which the operation part can move from the first operation position to the second operation position.

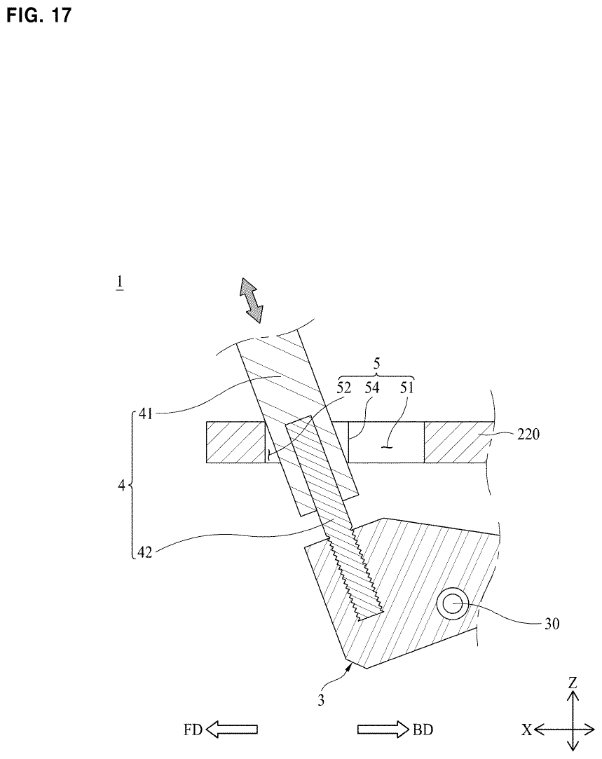

Next, as illustrated in FIG. 17, after the operation member 41 moves toward the front (in the FD arrow direction) and the operation part 4 moves from the first operation position toward the second operation position, the operation member 41 can be lowered together with the coupling member 42 to be inserted into the step plate 220. In this case, the operation member 41 can be inserted into the permission hole 52. Accordingly, by being supported by the protrusion member 54, the operation part 4 can be firmly maintained in the second operation position. Therefore, after moving from the restriction position to the permission position, the mounting controller 3 can be maintained in the permission position, and the mounting part 2 can be switched from the mounted state to the released state and be maintained in the released state.

As described above, by using the ascent and descent of the coupling member 42 through the screw coupling between the coupling member 42 and the mounting controller 3, the operation part 4 moves from the first operation position to the second operation position and is maintained in the second operation position. So, the mounting controller 3 can be moved from the restriction position to the permission position and be maintained in the permission position, and the mounting part 2 can be switched from the mounted state into the released state and be maintained in the released state. Since the process where the operation part 4 moves from the second operation position to the first operation position and is maintained in the first operation position, the mounting controller 3 moves from the permission position to the restriction position, and the mounting part 2 is switched from the released state to the mounted state and maintained in the mounted state can be achieved by reversely performing the aforementioned process, a detailed description thereof will be omitted.

### Fourth Embodiment

According to a fourth embodiment, the operation restriction part 5 and the operation part 4 can be realized as follows.

Referring to FIGS. 4 to 18, the operation restriction part 5 can be realized to be roughly identical to the description of the first embodiment, so a detailed description of the operation restriction part will be omitted.

Referring to FIGS. 4 to 18, compared to the first embodiment, the operation part 4 of the second embodiment has a difference in that the operation part 4 does not have the lifting hole 43. Instead of the lifting hole 43, the operation part 4 according to the fourth embodiment can include an operation restriction member 44. Since the operation part 4 can be configured to be roughly identical to that of the first embodiment except including the operation restriction member 44 instead of the lifting hole 43, hereinafter, differences between the second embodiment and the first embodiment will be described.

The operation restriction member 44 can be liftably coupled to the operation member 41. The operation restriction member 44 can be formed with a horizontal cross-sectional area larger than that of the connection hole 53. In this case, based on the second axial direction (Y-axis direction), the width 530 of the connection hole 53 can be formed shorter than the width of the operation restriction member 44 by the protrusion member 54. Therefore, the operation restriction member 44 is configured not to pass through the connection hole 53. Moreover, the operation restriction member 44 can be inserted into the restriction hole 51 to be supported by the protrusion member 54, and can be inserted into the permission hole 52 to be supported by the protrusion member 54. Accordingly, the operation part 4 can be limited in movement by the operation restriction member 44 and the protrusion member 54 at each of the first and second operation positions. The operation restriction member 44 can be formed to have a horizontal cross-sectional area of the same size as each of the restriction hole 51 and the permission hole 52. The operation restriction member 44 can be formed to be smaller than that of each of the restriction hole 51 and the permission hole 52. Therefore, the operation restriction member 44 can be inserted into the restriction hole 51 to be supported by the protrusion member 54 and can be inserted into the permission hole 52 to be supported by the protrusion member 54.

The operation restriction member 44 can be liftably coupled to the operation member 41. The operation restriction member 44 can be fastened to the operation member 41 through the spiral thread to be coupled in a liftable manner. The operation restriction member 44 can be liftably coupled to the operation member 41 using a groove and a protrusion inserted into the groove.

Meanwhile, the coupling member 42 can be coupled to the mounting controller 3 through the connection member 31. In this case, the coupling member 42 can be coupled to the mounting controller 3 so as not to ascend or descend. Accordingly, in the state in which the coupling member 42 does not ascend or descend, the operation restriction member 44 can ascend relative to the operation member 41 to be spaced upward from the step plate 220, and can descend relative to the operation member 41 to be inserted into the step plate 220. Thus, the operation part 4 can not only move the mounting controller 3 between the restriction position and the permission position while moving between the first and second operation positions but also be limited in movement by being supported by the operation restriction part 5 at each of the first and second operation positions. The above will be described in detail as follows.

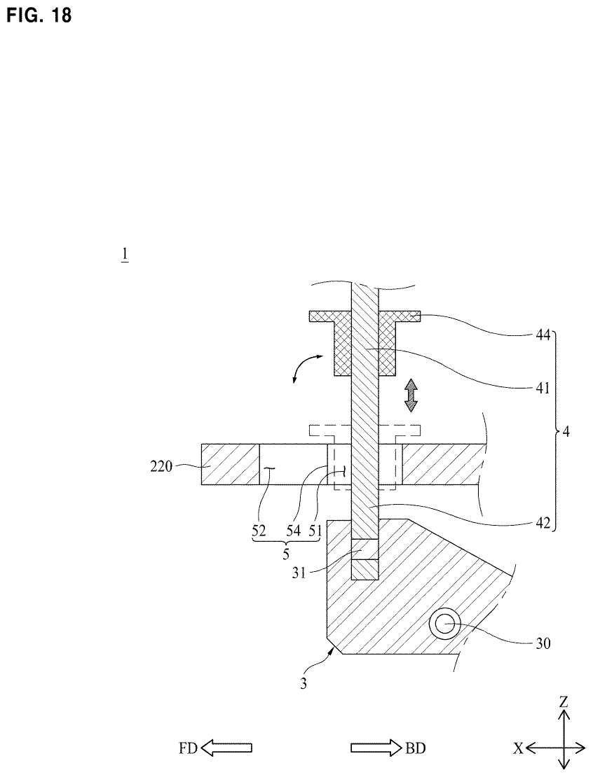

First, as illustrated in dotted lines in FIG. 18, when the operation part 4 is located at the first operation position, the operation restriction member 44 can be lowered relative to the operation member 41 and inserted into the step plate 220. In this case, the operation restriction member 44 can be inserted into the restriction hole 51. Accordingly, since the operation restriction member 44 is supported by the protrusion member 54, the operation part 4 can be firmly maintained at the first operation position. Therefore, the mounting controller 3 can be maintained in the restriction position, and the mounting part 2 can be maintained in the mounted state.

Next, as illustrated in solid lines in FIG. 18, when the operation restriction member 44 is raised relative to the operation member 41, the operation restriction member 44 can be spaced upward from the step plate 220. Accordingly, the operation restriction member 44 can be separated from the restriction hole 51, thereby no longer being supported by the protrusion member 54. Therefore, the operation part 4 can be switched to a state in which the operation part 4 can move from the first operation position to the second operation position.

Next, after the operation member 41 moves forward (in the FD arrow direction) and the operation part 4 moves from the first operation position towards the second operation position, the operation restriction member 44 can be lowered relative to the operation member 41 and inserted into the step plate 220. In this case, the operation restriction member 44 can be inserted into the permission hole 52. Accordingly, since the operation restriction member 44 is supported by the protrusion member 54, the operation part 4 can be firmly maintained at the second operation position. Therefore, the mounting controller 3 can move from the restriction position to the permission position and can be maintained in the permission position, and the mounting part 2 can be switched from the mounted state into the released state and be maintained in the released state.

As described above, by using the ascent and descent of the operation restriction member 44 relative to the operation member 41, the operation part 4 moves from the first operation position to the second operation position and is maintained in the second operation position. So, the mounting controller 3 can be moved from the restriction position to the permission position and be maintained in the permission position, and the mounting part 2 can be switched from the mounted state into the released state and be maintained in the released state. Since the process where the operation part 4 moves from the second operation position to the first operation position and is maintained in the first operation position, the mounting controller 3 moves from the permission position to the restriction position, and the mounting part 2 is switched from the released state to the mounted state and maintained in the mounted state can be achieved by reversely performing the aforementioned process, a detailed description thereof will be omitted.

Meanwhile, the connection hole 53 can be formed with the same horizontal cross-sectional area as the operation member 41 or larger than the horizontal cross-sectional area of the operation member 41. Accordingly, the operation member 41 can move between the restriction hole 51 and the permission hole 52 via the connection hole 53 without interference from the protrusion member 54. The operation member 41 and the coupling member 42 can be formed to have a horizontal cross-section of the same size.

### Fifth Embodiment

According to a fifth embodiment, the operation restriction part 5 and the operation part 4 can be realized as follows.

Referring to FIGS. 4 through 21, the operation restriction part 5 may include a restriction hole 51, a permission hole 52, a connection hole 53, and a protrusion member 54.

The restriction hole 51 is formed in the step plate 220. The restriction hole 51 may be formed to pass through the step plate 220. When the operation part 4 is inserted into the restriction hole 51, the operation part 4 can be located at the first operation position.

The permission hole 52 is formed in the step plate 220. The permission hole 52 may be formed to pass through the step plate 220. When the operation part 4 is inserted into the permission hole 52, the operation part 4 can be located at the second operation position.

The permission hole 52 and the restriction hole 51 can be arranged to be spaced apart in the first axial direction (X-axis direction). Based on the first axial direction (X-axis direction), the permission hole 52 can be arranged forward (in the FD arrow direction) relative to the restriction hole 51. In this case, the restriction hole 51 can be arranged backward (in the BD arrow direction) relative to the permission hole 52.

The connection hole 53 is formed in the step plate 220. The connection hole 53 may be formed to pass through the step plate 220. The connection hole 53 can be connected to each of the restriction hole 51 and the permission hole 52. The connection hole 53 may include a first communication hole 531, a second communication hole 532, and a movement hole 533.

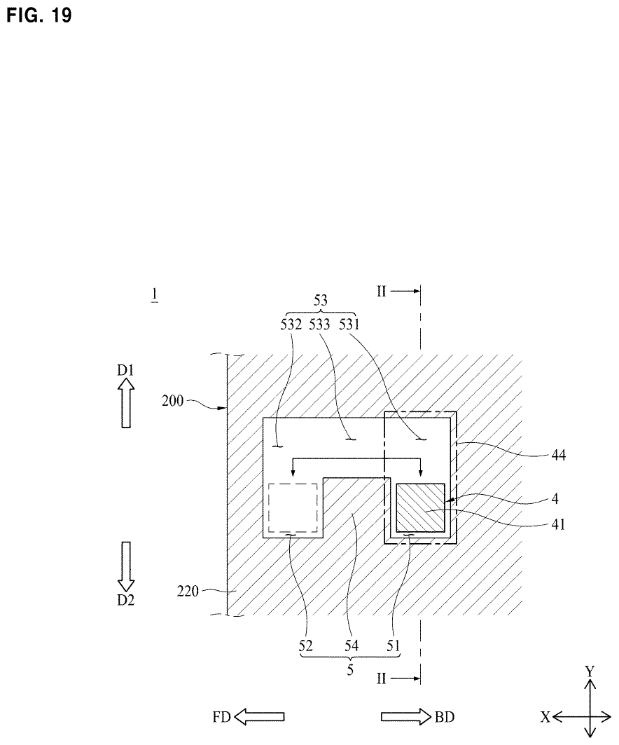

The first communication hole 531 is connected to the restriction hole 51. The first communication hole 531 can be formed parallel to the second axial direction (Y-axis direction). The first communication hole 531 can be formed in the first direction (in the D1 arrow direction) from the restriction hole 51. The first direction (in the D1 arrow direction) can be one of the two directions of the second axial direction (Y-axis direction). In this case, the restriction hole 51 can be arranged in the second direction (in the D2 arrow direction) relative to the first communication hole 531. The second direction (in the D2 arrow direction) is the opposite direction to the first direction (in the D1 arrow direction) among the two directions of the second axial direction (Y-axis direction). Referring to FIG. 19, the first communication hole 531 can be formed upward from the restriction hole 51, and the restriction hole 51 can be positioned downward relative to the first communication hole 531.

The second communication hole 532 is connected to the permission hole 52. The second communication hole 532 can be formed parallel to the second axial direction (Y-axis direction). The second communication hole 532 can be formed in the first direction (in the D1 arrow direction) from the permission hole 52. In this case, the permission hole 52 can be arranged in the second direction (in the D2 arrow direction) relative to the second communication hole 532. Referring to FIG. 19, the second communication hole 532 can be formed upward from the permission hole 52, and the permission hole 52 can be positioned downward relative to the second communication hole 532.

The movement hole 533 is connected to each of the first communication hole 531 and the second communication hole 532. The movement hole 533 can be arranged between the first communication hole 531 and the second communication hole 532. The movement hole 533 can extend parallel to the first axial direction (X-axis direction). When the operation part 4 is moved between the first operation position and the second operation position, the operation part 4 can move between the restriction hole 51 and the permission hole 52 via the first communication hole 531, the movement hole 533, and the second communication hole 532.

The protrusion member 54 is arranged between the restriction hole 51 and the permission hole 52 based on the first axial direction (X-axis direction). Accordingly, the protrusion member 54 can support the operation part 4 inserted into the restriction hole 51, thereby restricting the movement of the operation part 4 located at the first operation position. The protrusion member 54 can support the operation part 4 inserted into the permission hole 52, thereby restricting the movement of the operation part 4 located at the second operation position. As described above, according to the fifth embodiment, the agricultural work machine mounting device 1 according to the disclosure is configured such that the operation part 4 can be maintained at either the first operation position or the second operation position using the protrusion member 54 even if the worker does not continuously apply force to the operation part, thereby maintaining the mounting part 2 in either the mounted state or the released state. The protrusion member 54 can be arranged in the second direction (in the D2 arrow direction) relative to the movement hole 533.

Referring to FIGS. 4 through 21, the operation part 4 may include an operation member 41, a coupling member 42, and an operation restriction member 44.

The operation member 41 is coupled on the coupling member 42. The operation member 41 can protrude upward from the coupling member 42. An upper portion of the operation member 41 can protrude above the step plate 220. The worker can operate the operation member 41 to move the operation part 4 between the first operation position and the second operation position. The operation member 41 can be formed to have a horizontal cross-sectional area of the same size as each of the restriction hole 51, the connection hole 53, and the permission hole 52. Alternatively, the horizontal cross-sectional area of the operation member 41 can be smaller than that of the restriction hole 51, the connection hole 53, and the permission hole 52. Accordingly, the operation member 41 can be inserted into the restriction hole 51 to be located at the first operation position, can be inserted into the permission hole 52 to be located at the second operation position, and can move between the restriction hole 51 and the permission hole 52 via the connection hole 53.

The coupling member 42 is coupled to the mounting controller 3. The operation member 41 can be coupled to the coupling member 42. Accordingly, as the operation member 41 moves between the first operation position and the second operation position, the coupling member 42 can move. Moreover, through the coupling member 42, the mounting controller 3 can move between the restriction position and the permission position. Therefore, the mounting part 2 can be switched between the mounted state and the released state.

The coupling member 42 can be rotatably coupled to the mounting controller 3. In this case, the operation member 41 is coupled on the coupling member 42 and can be arranged to rotate relative to the mounting controller 3. The coupling member 42 can rotate around a rotational shaft 42a arranged parallel to the first axial direction (X-axis direction). Accordingly, the coupling member 42 can be rotatably coupled to the mounting controller 3 in the second axial direction (Y-axis direction). The coupling member 42 can be rotatably coupled to the mounting controller 3 through the connection member 31. In this case, the connection member 31 can function as the rotational shaft 42a for the coupling member 42. Through the connection member 31, the coupling member 42 can be coupled to the mounting controller 3 not to be raised and lowered.

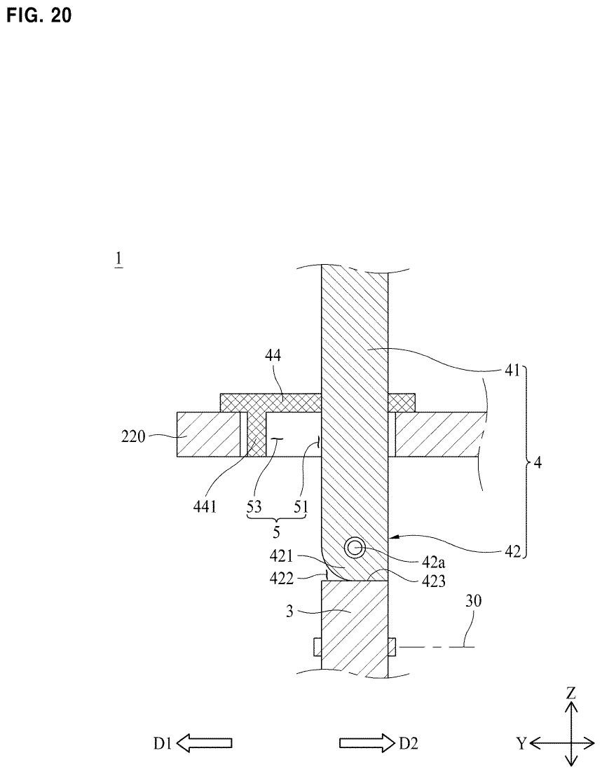

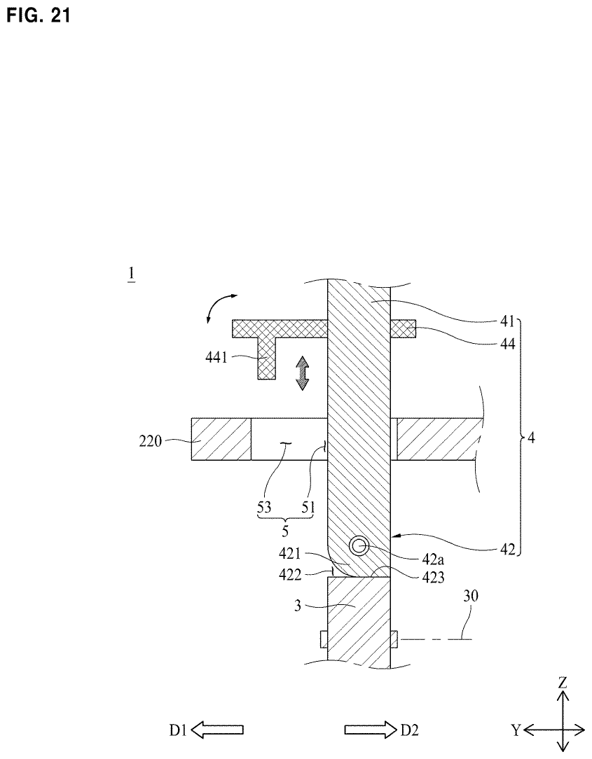

The operation restriction member 44 can be coupled to the operation member 41 to allow for ascent and descent. As illustrated in FIG. 20, when the operation restriction member 44 descends and is in contact with the step plate 220, the operation restriction member 44 can be supported by the step plate 220, thereby restricting the rotation of the operation member 41. Accordingly, the coupling member 42 cannot rotate around the rotational shaft 42a, thereby preventing the operation member 41 from moving from the restriction hole 51 and the permission hole 52 to the connection hole 53. Therefore, the operation part 4 can be maintained in each of the first operation position and the second operation position. As illustrated in FIG. 21, when the operation restriction member 44 is raised and is spaced apart from the step plate 220, the operation restriction member 44 is no longer supported by the step plate 220, thereby allowing the rotation of the operation member 41. Accordingly, the coupling member 42 can be switched to be rotatable around the rotational shaft 42a, so that the operation member 41 can move from the restriction hole 51 and the permission hole 52 to the connection hole 53. Therefore, since the operation member 41 can move between the restriction hole 51 and the permission hole 52 via the connection hole 53, the operation part 4 can move between the first operation position and the second operation position.

Here, the process in which the operation part 4 is moved from the first operation position to the second operation position will be described in detail as follows.

First, in the state in which the operation restriction member 44 is raised, the operation member 41 can be rotated in the first direction (in the D1 arrow direction) from the restriction hole 51 and inserted into the first communication hole 531.

Next, the operation member 41 can move forward (in the FD arrow direction) along the movement hole 533 toward the second communication hole 532.

Next, the operation member 41 can be rotated in the second direction (in the D2 arrow direction) from the second communication hole 532 and inserted into the permission hole 52.

Next, the operation restriction member 44 can be lowered to be supported by the step plate 220.

Through the above process, the operation part 4 is moved from the first operation position to the second operation position and is maintained in the second operation position, so the mounting controller 3 is moved from the restriction position to the permission position and is maintained in the permission position, and the mounting part 2 can be switched from the mounted state into the released state and can be maintained in the released state.

Here, the process in which the operation part 4 moves from the second operation position to the first operation position will be described in detail as follows.

First, in the state in which the operation restriction member 44 is raised, the operation member 41 can be rotated in the first direction (in the D1 arrow direction) from the permission hole 52 and inserted into the second communication hole 532.

Next, the operation member 41 can move rearward (in the BD arrow direction) along the movement hole 533 toward the first communication hole 531.

Next, the operation member 41 can be rotated in the second direction (in the D2 arrow direction) from the first communication hole 531 and inserted into the restriction hole 51.

Next, the operation restriction member 44 can be lowered to be supported by the step plate 220.

Through the above process, the operation part 4 is moved from the second operation position to the first operation position and is maintained in the first operation position, so the mounting controller 3 is moved from the permission position to the restriction position and is maintained in the restriction position, and the mounting part 2 can be switched from the released state into the mounted state and can be maintained in the mounted state.

The operation restriction member 44 can be fastened to the operation member 41 through the spiral thread or similar means, so as to be liftably coupled to the operation member 41. The operation restriction member 44 can also be liftably coupled to the operation member 41 using a groove and a protrusion inserted into the groove for ascent and descent.

The operation restriction member 44 can have a restricting protrusion 441 formed thereon. The restricting protrusion 441 can protrude downward from the underside of the operation restriction member 44. When the operation restriction member 44 is lowered and is supported by the step plate 220, the restricting protrusion 441 can be inserted into the connection hole 53 and supported by the inner surface of the step plate 220 facing the connection hole 53. Therefore, the restricting protrusion 441 can enhance the blocking force preventing the rotation of the operation part 4 in the state in which the operation restriction member 44 is supported by the step plate 220.

Meanwhile, the operation restriction member 44 can be formed to be longer than the sum of the length of the restriction hole 51 and the length of the connection hole 53 based on the second axial direction (Y-axis direction). Accordingly, when the operation part 4 is located at the first operation position, the operation restriction member 44 can be stably supported by the step plate 220, thereby restricting the rotation of the operation part 4. In this case, the operation restriction member 44 can be formed to protrude toward both sides of the restriction hole 51 and the connection hole 53 based on the second axial direction (Y-axis direction). The operation restriction member 44 can also be formed to be longer than the sum of the length of the permission hole 52 and the length of the connection hole 53 based on the second axial direction (Y-axis direction). Accordingly, when the operation part 4 is located at the second operation position, the operation restriction member 44 can be stably supported by the step plate 220, thereby restricting the rotation of the operation part 4. In this case, the operation restriction member 44 can be formed to protrude toward both sides of the permission hole 52 and the connection hole 53 based on the second axial direction (Y-axis direction).

Furthermore, the operation restriction member 44 can be formed to be longer than the length of the restriction hole 51 based on the first axial direction (X-axis direction). Accordingly, when the operation part 4 is located at the first operation position, the operation restriction member 44 can be stably supported by the step plate 220, thereby restricting the rotation of the operation part 4. In this instance, the operation restriction member 44 can be formed to protrude toward both sides of the restriction hole 51 based on the first axial direction (X-axis direction). The operation restriction member 44 can also be formed to be longer than the length of the permission hole 52 based on the first axial direction (X-axis direction). Accordingly, when the operation part 4 is located at the second operation position, the operation restriction member 44 can be stably supported by the step plate 220, thereby restricting the rotation of the operation part 4. In this case, the operation restriction member 44 can be formed to protrude toward both sides of the permission hole 52 based on the first axial direction (X-axis direction).

Here, when the operation part 4 is located at the first operation position and the second operation position, the coupling member 42 can be configured to allow the operation member 41 to rotate only in the first direction (in the D1 arrow direction). For this purpose, the coupling member 42 can include a floor member 421, a permission groove 422, and a blocking surface 423.

The floor member 421 is positioned to face the mounting controller 3 when the operation part 4 is at the first and second operation positions. The floor member 421 may correspond to a lower portion of the coupling member 42. The floor member 421 can be rotatably coupled to the mounting controller 3 through the connection member 31.

The permission groove 422 is formed in the floor member 421. The permission groove 422 can be configured as a groove of a predetermined depth formed on the bottom surface of the floor member 421. When the operation part 4 is located at the first and second operation positions, the permission groove 422 can be arranged in the first direction (in the D1 arrow direction) relative to the rotational shaft 42a. Accordingly, when the operation part 4 is located at the first and second operation positions, the operation part 4 can be configured to rotate in the first direction (in the D1 arrow direction) through the permission groove 422. A portion of the floor member 421 where the permission groove 422 is formed can be shaped into a curved surface.

The blocking surface 423 is formed on the floor member 421. The blocking surface 423 may belong to the bottom surface of the floor member 421. When the operation part 4 is located at the first and second operation positions, the blocking surface 423 can be supported by the mounting controller 3. Additionally, when the operation part 4 is at the first and second operation positions, the blocking surface 423 can be positioned in the second direction (in the D2 arrow direction) relative to the rotational shaft 42a. Accordingly, when the operation part 4 is located at the first and second operation positions, the operation part 4 can be configured to block rotation in the second direction (in the D2 arrow direction) as the blocking surface 423 is supported by the mounting controller 3. A portion of the floor member 421 where the blocking surface 423 is formed can be shaped into a flat surface.

As described above, when the operation part 4 is located at the first and second operation positions, the operation part 4 can be configured to rotate only in the first direction (in the D1 arrow direction) using the permission groove 422 and the blocking surface 423. Therefore, the agricultural work machine mounting device 1 according to the disclosure can enhance the stability and ease of moving the operation part 4 between the first and second operation positions.

### Sixth Embodiment

According to a sixth embodiment, the operation restriction part 5 and the operation part 4 can be realized as follows.

Referring to FIGS. 4 through 24, the operation restriction part 5 may include a restriction hole 51, a permission hole 52, a connection hole 53, a protrusion member 54, and a locking mechanism 55.

The restriction hole 51 is formed in the step plate 220. The restriction hole 51 may be formed by passing through the step plate 220. When the operation part 4 is inserted into the restriction hole 51, the operation part 4 can be located at the first operation position.

The permission hole 52 is formed in the step plate 220. The permission hole 52 may be formed by passing through the step plate 220. When the operation part 4 is inserted into the permission hole 52, the operation part 4 can be located at the second operation position.

The permission hole 52 and the restriction hole 51 can be arranged to be spaced apart from each other in the first axial direction (X-axis direction). Based on the first axial direction (X-axis direction), the permission hole 52 can be positioned forward (in the FD arrow direction) relative to the restriction hole 51. In this case, the restriction hole 51 can be positioned backward (in the BD arrow direction) relative to the permission hole 52.

The connection hole 53 is formed in the step plate 220. The connection hole 53 may be formed by passing through the step plate 220. The connection hole 53 can be connected to each of the restriction hole 51 and the permission hole 52. The connection hole 53 may include a first communication hole 531, a second communication hole 532, and a movement hole 533.

The first communication hole 531 is connected to the restriction hole 51. The first communication hole 531 can be formed to be inclined with respect to each of the first axial direction (X-axis direction) and the second axial direction (Y-axis direction). The first communication hole 531 can be formed in the second direction (in the D2 arrow direction) from the restriction hole 51. The first communication hole 531 can be inclined such that an included angle between the first communication hole 531 and the restriction hole 51 forms an obtuse angle and an included angle between the first communication hole 531 and the movement hole 533 also forms an obtuse angle. Accordingly, the first communication hole 531 can extend from the restriction hole 51 in the second direction (in the D2 arrow direction) and in the forward direction (in FD arrow direction).

The second communication hole 532 is connected to the permission hole 52. The second communication hole 532 can be formed parallel to the second axial direction (Y-axis direction). The second communication hole 532 can be formed in the second direction (in the D2 arrow direction) from the permission hole 52. In this case, the permission hole 52 can be arranged in the first direction (in the D2 arrow direction) relative to the second communication hole 532. The permission hole 52 can be arranged in the backward direction (in the BD arrow direction) relative to the second communication hole 532.

The movement hole 533 is connected to each of the first communication hole 531 and the second communication hole 532. The movement hole 533 can be positioned between the first communication hole 531 and the second communication hole 532. The movement hole 533 can extend parallel to the first axial direction (X-axis direction). When the operation part 4 moves between the first operation position and the second operation position, the operation part 4 can move between the restriction hole 51 and the permission hole 52 via the first communication hole 531, the movement hole 533, and the second communication hole 532.

The protrusion member 54 is arranged between the restriction hole 51 and the permission hole 52 based on the first axial direction (X-axis direction). Accordingly, the protrusion member 54 can support the operation part 4 inserted into the permission hole 52, thereby restricting the movement of the operation part 4 at the second operation position. The protrusion member 54 can be arranged in the first direction (in the D1 arrow direction) relative to the movement hole 533. The first inner surface of the protrusion member 54 facing the first communication hole 531 can be formed as an inclined surface. The second inner surface of the protrusion member 54 facing the second communication hole 532 can also be formed as an inclined surface. The first and second inner surfaces can be inclined in the same direction.

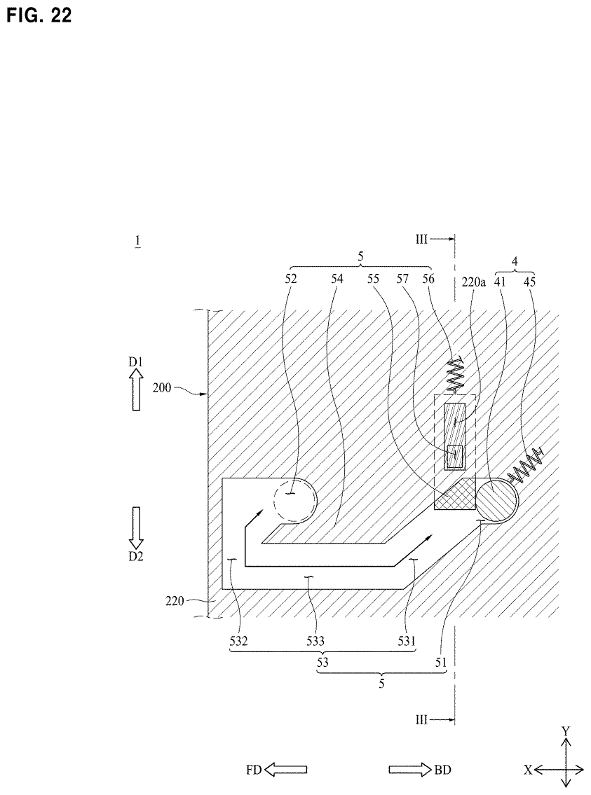

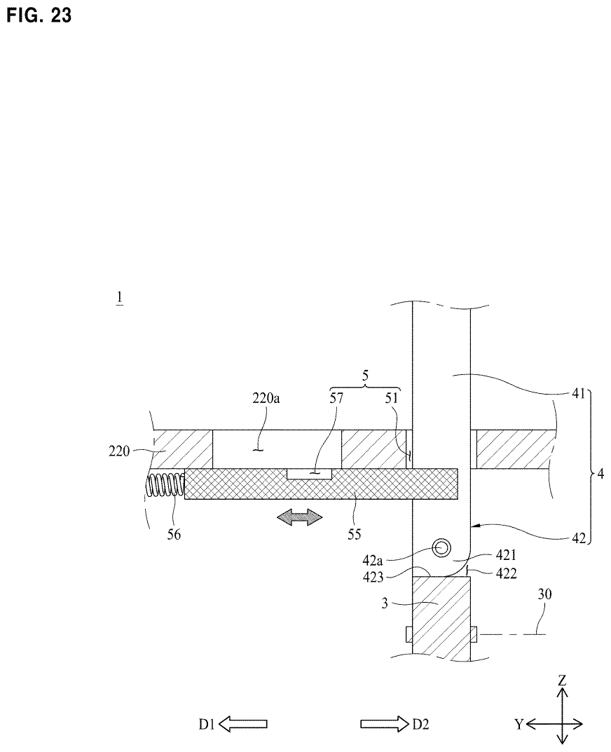

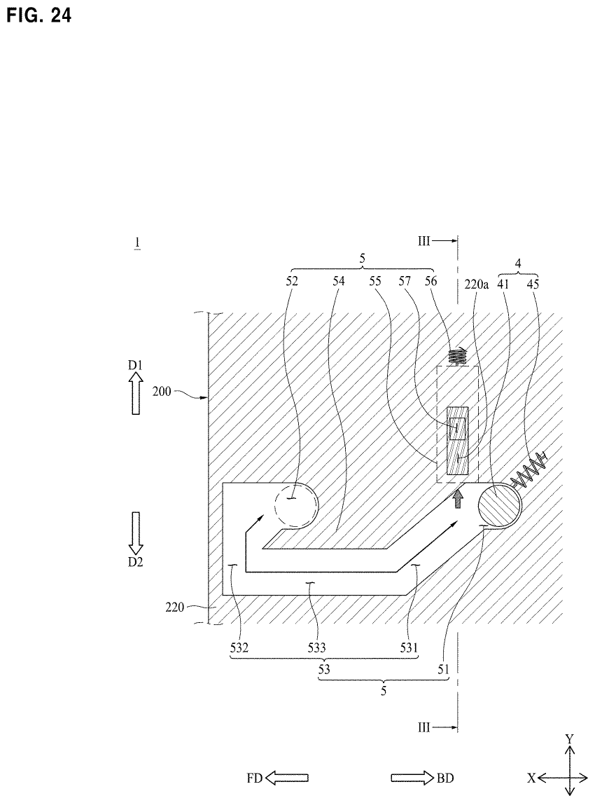

The locking mechanism 55 is coupled to the step plate 220 to be movable between a blocking position and a passing position. As illustrated in FIGS. 22 and 23, when the locking mechanism 55 is located at the blocking position, the locking mechanism 55 can prevent the operation part 4, which is located at the first operation position, from moving to the connection hole 53. In this case, the locking mechanism 55 can be arranged in a position where locking mechanism can support the operation part 4 at the blocking position. As illustrated in FIG. 24, when the locking mechanism 55 is located at the passing position, the locking mechanism 55 can allow the operation part 4 located at the first operation position to move to the connection hole 53. In this case, the locking mechanism 55 can be arranged in a position where the locking mechanism 55 cannot support the operation part 4 at the passing position. The locking mechanism 55 can be coupled to the step plate 220 to be movable between the blocking position and the passing position beneath the step plate 220.

The operation restriction part 5 can include a locking elastic member 56.

The locking elastic member 56 provides elastic force to the locking mechanism 55 in the direction to move the locking mechanism 55 toward the blocking position. Accordingly, when no external force is applied to the locking mechanism 55, the locking mechanism 55 can be located at the blocking position due to the elastic force provided by the locking elastic member 56. Therefore, the agricultural work machine mounting device 1 according to the present disclosure can maintain the operation part 4 in the first operation position using the locking elastic member 56 and the locking mechanism 55 even if the worker does not continuously apply force to the operation part 4, thereby maintaining the mounting controller 3 in the restriction position and maintaining the mounting part 2 in the mounted state. One side of the locking elastic member 56 can be coupled to the locking mechanism 55 and the other side can be coupled to the step plate 220. The locking elastic member 56 can be configured as a spring.

The operation restriction part 5 may include a locking operation part 57.

The locking operation part 57 is intended for moving the locking mechanism 55 between the blocking position and the passing position. The worker can move the locking mechanism 55 between the blocking position and the passing position by operating the locking operation part 57. The locking operation part 57 can be configured as a groove formed on the upper surface of the locking mechanism 55. In this case, the step plate 220 may include a through-hole 220a formed at a position corresponding to the locking operation part 57. The through-hole 220a can be formed to pass through the step plate 220. The worker can operate the locking operation part 57 through the through-hole 220a. The locking operation part 57 can be configured as a lever protruding upward from the upper surface of the locking mechanism 55. In this case, the locking operation part 57 can be inserted into the through-hole 220a and protrude above the step plate 220 to allow the worker to operate the locking operation part 57. If the locking elastic member 56 is provided, the worker can apply external force to the locking operation part 57 to move the locking mechanism 55 to the passing position, and remove the external force applied to the locking operation part 57 to move the locking mechanism 55 to the blocking position.

Referring to FIGS. 4 through 24, the operation part 4 may include an operation member 41, a coupling member 42, and an operation elastic member 45.

The operation member 41 is coupled on the coupling member 42. The operation member 41 can protrude upward from the coupling member 42. An upper portion of the operation member 41 can protrude above the step plate 220. The worker can operate the operation member 41 to move the operation part 4 between the first operation position and the second operation position. The operation member 41 can be formed to have a horizontal cross-sectional area with the same size as each of the restriction hole 51, the connection hole 53, and the permission hole 52. Alternatively, the operation member 41 can be formed to have a horizontal cross-sectional area smaller than those of the restriction hole 51, the connection hole 53, and the permission hole 52. Accordingly, the operation member 41 can be inserted into the restriction hole 51 to be located at the first operation position, and into the permission hole 52 to be located at the second operation position, and can move between the restriction hole 51 and the permission hole 52 via the connection hole 53.

The coupling member 42 is coupled to the mounting controller 3. The coupling member 42 can be coupled to the operation member 41. Accordingly, as the operation member 41 moves between the first operation position and the second operation position, the coupling member 42 can move, and the mounting controller 3 can move between the restriction position and the permission position through the coupling member 42. Therefore, the mounting part 2 can be switched between the mounted state and the released state.

The coupling member 42 can be rotatably coupled to the mounting controller 3. In this case, the operation member 41 is coupled on the coupling member 42 and can be positioned to rotate relative to the mounting controller 3. The coupling member 42 can be rotated around a rotational shaft 42a arranged parallel to the first axial direction (X-axis direction). Accordingly, the coupling member 42 can be rotatably coupled to the mounting controller 3 in the second axial direction (Y-axis direction). The coupling member 42 can be rotatably coupled to the mounting controller 3 through the connection member 31. In this instance, the connection member 31 can function as the rotational shaft 42a of the coupling member 42. Through the connection member 31, the coupling member 42 can be coupled to the mounting controller 3 so that the coupling member 42 does not ascend or descend.

The operation elastic member 45 provides elastic force to the operation member 41. One side of the operation elastic member 45 can be coupled to the operation member 41 and the other side can be coupled to the step plate 220. The other side of the operation elastic member 45 can be coupled to the step plate 220 at a position spaced backward (in the BD arrow direction) from each of the restriction hole 51 and the permission hole 52. The operation elastic member 45 can be configured as a spring. The operation elastic member 45 can be coupled to each of the operation member 41 and the step plate 220, beneath the step plate 220. The other side of the operation elastic member 45 can be coupled to the side frame 210 or other component beneath the step plate 220.

The operation elastic member 45 can provide elastic force to the operation member 41 in a direction that moves the operation member 41 located in the connection hole 53 toward the first operation position. In this instance, even if the locking mechanism 55 is located at the blocking position, the locking mechanism 55 can be moved to the passing position by being pressed to the operation member 41, which is moved toward the restriction hole 51 from the first communication hole 531 by the operation elastic member 45. Therefore, the agricultural work machine mounting device 1 according to the present disclosure can enhance the ease of moving the operation part 4 from the second operation position to the first operation position. When the locking elastic member 56 is coupled to the locking mechanism 55, the operation elastic member 45 can be formed to have a greater elastic force than the locking elastic member 56. Accordingly, even if the locking elastic member 56 is provided, the locking mechanism 55 can be moved to the passing position by being pressed to the operation member 41 moved from the first communication hole 531 towards the restriction hole 51 by the operation elastic member 45.

The operation elastic member 45 can provide elastic force to the operation member 41 in a direction to press the operation member 41 located at the second operation position toward the protrusion member 54. Therefore, the operation elastic member 45 can enhance the restricting force to restrict the movement of the operation part 4 located at the second operation position.

Here, the process in which the operation part 4 moves from the first operation position to the second operation position will be described in detail as follows.

First, as illustrated in FIG. 22, the locking mechanism 55 is located at the blocking position to restrict the movement of the operation part 4 located at the first operation position. The operation member 41 is inserted into the restriction hole 51.

Next, as illustrated in FIG. 24, when the locking mechanism 55 moves from the blocking position to the passing position, the operation member 41 inserted in the restriction hole 51 can move forward (in the FD arrow direction) and rotate in the second direction (in the D2 arrow direction), so as to be moved toward the movement hole 533 along the first communication hole 531.

Next, the operation member 41 inserted into the movement hole 533 can move forward (in the FD arrow direction) toward the second communication hole 532 along the movement hole 533.

Next, the operation member 41 can rotate in the first direction (in the D1 arrow direction) from the second communication hole 532 and move backward (in the BD arrow direction) to be inserted into the permission hole 52. In this case, the operation member 41 is moved towards the permission hole 52 by the elastic force of the operation elastic member 45 and can be in close contact with the protrusion member 54 in the permission hole 52.

Through the above process, the operation part 4 can moved from the first operation position to the second operation position and then be maintained at the second operation position, so the mounting controller 3 can be moved from the restriction position to the permission position and be maintained at the permission position, and the mounting part 2 can be switched from the mounted state into the released state and be maintained in the released state.

Now, the process in which the operation part 4 is moved from the second operation position to the first operation position will be described in detail as follows.

First, the operation member 41 is inserted in the permission hole 52, and the locking mechanism 55 is located at the blocking position.

Next, the operation member 41 inserted in the permission hole 52 can move forward (in the FD arrow direction) and rotate in the second direction (in the D2 arrow direction), and then move to the movement hole 533 along the second communication hole 532.

Next, the operation member 41 inserted into the movement hole 533 can move backward (in the BD arrow direction), and then, move towards the first communication hole 531 along the movement hole 533. In this case, the elastic force of the operation elastic member 45 can act in the direction to move the operation member 41 inserted into the second communication hole 532 toward the first communication hole 531 through the movement hole 533.

Next, the operation member 41 can rotate in the first direction (in the D1 arrow direction) from the first communication hole 531 and move backward (in the BD arrow direction) to be inserted into the restriction hole 51. During the above process, the operation member 41 can push the locking mechanism 55 located at the blocking position to be inserted into the restriction hole 51 while moving the locking mechanism 55 toward the passing position. The elastic force of the operation elastic member 45 can act to move the operation member 41 inserted in the first communication hole 531 towards the restriction hole 51. Once the operation member 41 is inserted into the restriction hole 51, the locking mechanism 55 can be moved from the passing position to the blocking position by the elastic force of the locking elastic member 56, thereby supporting the operation member 41 inserted in the restriction hole 51 and restricting the movement of the operation part 4 at the first operation position.

Through the above process, the operation part 4 is moved from the second operation position to the first operation position and is maintained in the first operation position, so the mounting controller 3 is moved from the permission position to the restriction position and is maintained in the restriction position, and the mounting part 2 can be switched from the released state into the mounted state and can be maintained in the mounted state.

When the operation part 4 is located at the first operation position and the second operation position, the coupling member 42 can be configured to allow the operation member 41 to rotate only in the second direction (in the D2 arrow direction). For this purpose, the coupling member 42 can include a floor member 421, a permission groove 422, and a blocking surface 423.

The floor member 421 is positioned to face the mounting controller 3 when the operation part 4 is located at the first operation position and the second operation position. The floor member 421 may correspond to a lower portion of the coupling member 42. The floor member 421 can be rotatably coupled to the mounting controller 3 through the connection member 31.

The permission groove 422 is formed in the floor member 421. The permission groove 422 can be configured as a groove formed on the bottom surface of the floor member 421 to a predetermined depth. When the operation part 4 is located at the first operation position and the second operation position, the permission groove 422 can be arranged in the second direction (in the D2 arrow direction) relative to the rotational shaft 42a. Accordingly, when the operation part 4 is located at both the first operation position and the second operation position, the operation part 4 can be configured to rotate in the second direction (in the D2 arrow direction) through the permission groove 422. A portion of the floor member 421 where the permission groove 422 is formed may be shaped into a curved surface.

The blocking surface 423 is formed on the floor member 421. The blocking surface 423 may belong to the bottom surface of the floor member 421. When the operation part 4 is located at the first operation position and the second operation position, the blocking surface 423 can be supported by the mounting controller 3. Additionally, when the operation part 4 is located at the first operation position and the second operation position, the blocking surface 423 can be arranged in the first direction (in the D1 arrow direction) relative to the rotational shaft 42a. Therefore, when the operation part 4 is located at the first operation position and the second operation position, the operation part 4 can be configured to be prevented from being rotated in the first direction (in the D1 arrow direction) by being supported by the mounting controller 3. A portion of the floor member 421 where the blocking surface 423 is formed may be shaped into a flat surface.

As described above, when the operation part 4 is located at the first operation position and the second operation position, the operation part 4 can be configured to rotate only in the second direction (in the D2 arrow direction) using the permission groove 422 and the blocking surface 423. Therefore, the agricultural work machine mounting device 1 according to the present disclosure can enhance the stability and ease of moving the operation part 4 between the first operation position and the second operation position.

As described above, while the present disclosure has been described with reference to the example embodiments and the attached drawings thereof, it will be understood by those of ordinary skill in the art that various changes, modifications and equivalents can be made without departing from the technical spirit of the present disclosure.

1. A mounting device of an agricultural work machine, comprising:
a mounting part which is coupled to an agricultural work machine and is configured to be detachably mounted to an agricultural work vehicle;
a mounting controller which is coupled to the agricultural work machine and is configured to control movement of the mounting part;
an operation part which is coupled to the mounting controller and is configured to move the mounting controller, and
an operation restriction part for restricting movement of the operation part,
wherein the mounting part includes a first mounting mechanism rotatably coupled to the agricultural work machine, a second mounting mechanism rotatably coupled to the agricultural work machine, and an elastic mechanism providing elastic force to the first and second mounting mechanisms in a direction where a first mounting groove formed in the first mounting mechanism and a second mounting groove formed in the second mounting mechanism are spaced apart,
wherein the mounting controller is rotatably coupled to the agricultural work machine between a restriction position, where the mounting controller is inserted into a restriction groove of the mounting part to restrict the movement of the first mounting mechanism and the second mounting mechanism, and a permission position, where the mounting controller is spaced from the restriction groove to allow the movement of the first mounting mechanism and the second mounting mechanism by the elastic force of the elastic mechanism,
wherein the operation part moves between a first operation position, which locates the mounting controller at the restriction position, and a second operation position, which locates the mounting controller at the permission position, and
wherein the operation restriction part restricts the movement of the operation part located at the first operation position, and restricts the movement of the operation part located at the second operation position.

2. The mounting device of an agricultural work machine according to claim 1, wherein the operation restriction part includes a restriction hole formed in a step plate of the agricultural work machine, a permission hole formed in the step plate, a connection hole formed in the step plate to be disposed between the restriction hole and the permission hole, and a protrusion member protruding towards the connection hole,
wherein the operation part is inserted into the restriction hole to be located at the first operation position and is inserted into the permission hole to be located at the second operation position, and
wherein the protrusion member supports the operation part inserted into the restriction hole to restrict the movement of the operation part located at the first operation position, and supports the operation part inserted into the permission hole to restrict the movement of the operation part located at the second operation position.

3. The mounting device of an agricultural work machine according to claim 2, wherein the operation part includes a coupling member coupled to the mounting controller, and an operation member coupled on the coupling member,
wherein the operation member is formed to have a horizontal cross-sectional area larger than that of the coupling member,
wherein the coupling member is formed to have a horizontal cross-sectional area smaller than that of the connection hole, to be movable between the first operation position and the second operation position through the connection hole, and
wherein the connection hole is formed to be smaller than the horizontal cross-sectional area of the operation member by the protrusion member.

4. The mounting device of an agricultural work machine according to claim 3, wherein the operation part includes a lifting hole formed in the coupling member,
wherein the coupling member is liftably coupled to the mounting controller through the lifting hole, and
wherein the operation member is raised together with the coupling member to be spaced upward from the step plate, and is lowered together with the coupling member to be inserted into the step plate.

5. The mounting device of an agricultural work machine according to claim 3, wherein the operation member is liftably coupled to the coupling member, and
wherein the operation member is raised relative to the coupling member to be spaced upward from the step plate, and is lowered relative to the coupling member to be inserted into the step plate.

6. The mounting device of an agricultural work machine according to claim 3, wherein the coupling member is liftably coupled to the mounting controller through screw coupling, and
wherein the operation member is raised together with the coupling member to be spaced upward from the step plate, and is lowered together with the coupling member to be inserted into the step plate.

7. The mounting device of an agricultural work machine according to claim 2, wherein the operation part includes a coupling member coupled to the mounting controller, an operation member coupled on the coupling member, and an operation restriction member liftably coupled to the operation member,
wherein the connection hole is formed to be smaller than a horizontal cross-sectional area of the operation restriction member by the protrusion member,
wherein the protrusion member supports the operation restriction member inserted into the restriction hole to restrict the movement of the operation part located at the first operation position, and supports the operation restriction member inserted into the permission hole to restrict the movement of the operation part located at the second operation position, and
wherein the operation restriction member is raised relative to the operation member to be spaced upward from the step plate, and is lowered relative to the operation member to be inserted into the step plate.

8. The mounting device of an agricultural work machine according to claim 7, wherein the connection hole is formed to be the same size as the horizontal cross-sectional area of the operation member or larger than the horizontal cross-sectional area of the operation member.

9. The mounting device of an agricultural work machine according to claim 1, wherein the operation restriction member includes a restriction hole formed in the step plate of the agricultural work machine, a permission hole formed in the step plate at a position spaced apart from the restriction hole in a first axial direction, a connection hole formed in the step plate to connect each of the restriction hole and the permission hole, and a protrusion member arranged between the restriction hole and the permission hole based on the first axial direction,
wherein the operation part includes a coupling member rotatably coupled to the mounting controller around a rotational shaft arranged parallel to the first axial direction, an operation member coupled on the coupling member and rotatably arranged on the mounting controller, and an operation restriction member liftably coupled to the operation member, and
wherein the operation restriction member, when being lowered and in contact with the step plate, is supported by the step plate to restrict the rotation of the operation member, and when being raised and spaced apart from the step plate, allows the rotation of the operation member so that the operation member is movable between the restriction hole and the permission hole via the connection hole.

10. The mounting device of an agricultural work machine according to claim 9, wherein the coupling member is rotatably coupled to the mounting controller in a second axial direction perpendicular to the first axial direction, and
wherein the coupling member includes:
a floor member positioned toward the mounting controller when the operation part is located at the first operation position and the second operation position;
a permission groove formed on the floor member to be arranged toward the first direction relative to the rotational shaft so that, when the operation part is located at the first operation position and the second operation position, the operation part can rotate only in the first direction among two directions of the second axial direction; and
a blocking surface formed on the floor member to be arranged toward the second direction relative to the rotational shaft so that, when the operation part is located at the first operation position and the second operation position, the operation part is supported by the mounting controller to block the rotation of the operation part in the second direction, which is the opposite direction to the first direction among the two directions of the second axial direction.

11. The mounting device of an agricultural work machine according to claim 1, wherein the operation restriction member includes:
a restriction hole formed in a step plate of the agricultural work machine;
a permission hole formed in the step plate at a position spaced apart from the restriction hole in the first axial direction;
a connection hole formed in the step plate to be connected to each of the restriction hole and the permission hole;
a protrusion member positioned between the restriction hole and the permission hole based on the first axial direction to restrict the movement of the operation part located at the second operation position; and
a locking mechanism coupled to the step plate to be movable between a blocking position that prevents the operation part located at the first operation position from moving to the connection hole, and a passing position that allows the operation part located at the first operation position to move to the connection hole.

12. The mounting device of an agricultural work machine according to claim 11, wherein the operation part includes a coupling member rotatably coupled to the mounting controller, an operation member coupled on the coupling member and rotatably arranged with respect to the mounting controller, and an operation elastic member that provides elastic force to the operation member, and
wherein the operation elastic member provides elastic force to the operation member in a direction to move the operation member located in the connection hole toward the first operation position, and provide s elastic force to the operation member in a direction to press the operation member located at the second operation position toward the protrusion member.

13. The mounting device of an agricultural work machine according to claim 12, wherein the connection hole includes a first communication hole connected to the restriction hole, a second communication hole connected to the permission hole, and a movement hole connected to each of the first and second communication holes,
wherein the operation member moves between the restriction hole and the permission hole through the first communication hole, the movement hole, and the second communication hole, and
wherein the locking mechanism is moved to the passing position as the locking mechanism is pressed toward the operation member moving toward the restriction hole from the first communication hole by the elastic force of the operation elastic member.

14. The mounting device of an agricultural work machine according to claim 13, wherein the operation restriction member includes a locking elastic member that provides elastic force to the locking mechanism in the direction of moving the locking mechanism to the blocking position, and
wherein the operation elastic member is formed to have a greater elastic force than the locking elastic member.

15. The mounting device of an agricultural work machine according to claim 11, wherein the operation restriction member includes a locking operation part for moving the locking mechanism between the blocking position and the passing position.

16. The mounting device of an agricultural work machine according to claim 11, wherein the operation part includes a coupling member rotatably coupled to the mounting controller around a rotational shaft arranged parallel to the first axial direction, and an operation member coupled on the coupling member and rotatably arranged with respect to the mounting controller,
wherein the coupling member is rotatably coupled to the mounting controller in a second axial direction perpendicular to the first axial direction,
wherein the coupling member includes:
a floor member positioned toward the mounting controller when the operation part is located at the first operation position and the second operation position;
a blocking surface formed on the floor member to be arranged toward the first direction relative to the rotational shaft to block the rotation of the operation part in the first direction among two directions of the second axial direction when the operation part is located at the first operation position and the second operation position; and
a permission groove formed on the floor member to be arranged toward the second direction relative to the rotational shaft to allow the rotation of the operation part only in the second direction, which is the opposite direction to the first direction among the two directions of the second axial direction, when the operation part is located at the first operation position and the second operation position.

17. The mounting device of an agricultural work machine according to claim 1, wherein the agricultural work machine includes a step plate where a worker's feet are positioned, and a side frame placed beneath the step plate,
wherein the mounting part and the mounting controller are coupled to the side frame, and
wherein the operation restriction member is formed on the step plate.
